(19) United States
(12) Patent Application Publication
(10) Pub. No.: US 2026/0220830 A1
(43) Pub. Date: Jul. 30, 2026

(54) INFORMATION PROCESSING APPARATUS, INFORMATION PROCESSING SYSTEM, AND INFORMATION PROCESSING METHOD

(71) Applicant: Maxell, Ltd., Kyoto (JP)

(72) Inventors: Hiroshi NAKAMORI, Kyoto (JP); Hirohito KURIYAMA, Kyoto (JP); Yasunobu HASHIMOTO, Kyoto (JP); Kazuhiko YOSHIZAWA, Kyoto (JP)

(21) Appl. No.: 19/149,250

(22) PCT Filed: Jan. 20, 2023
(86) PCT No.: PCT/JP2023/001652

§ 371 Date: Jul. 18, 2025

(51) Int. Cl. G06T 11/00; G06F 3/01

(52) U.S. Cl. CPC G06T 11/00; G06F 3/013

(57) ABSTRACT

Provided is a technique capable of securing or maintaining visual recognition of a user with respect to a space where an avatar exists while maintaining a world view or a sense of presence of the space where the avatar exists. A processor and display are connected to a server configured to provide the space via a network. The processor is configured to execute, in cooperation with the server configured to provide the space, region setting processing setting a first region in which a user is interested in the image displayed; avatar specifying processing of specifying a first avatar different from an image in which the user is considered to be interested, based on a positional relationship with the first region; and avatar display control processing of controlling display of the first avatar such that the first avatar is entirely displayed outside the first region.

### TECHNICAL FIELD The present invention relates to an information processing apparatus, an information processing system, and an information processing method.

### BACKGROUND ART

In recent years, there has been known a technique in which avatars who are experiencing a space such as virtual reality or mixed reality together exist in the space, and an image representing the space where the avatars exist is provided so that a viewer can visually recognize the image.

In addition, Patent Document 1 describes a technique of temporarily hiding an avatar or making the avatar translucent in a case where the avatar enters between a CG model gazed by a viewer A and the viewer A in a mixed reality space. According to this technique, it is possible to prevent the CG model felt by the viewer from being obstructed by a joint viewer belonging to a different local coordinate space and being difficult to visually recognize.

### RELATED ART DOCUMENT

### Patent Document

Patent Document 1: Japanese Patent Application Laid-open Publication No. 2018-106297

### SUMMARY OF THE INVENTION

### Problems to be Solved by the Invention

However, according to the technique described in Patent Document 1, since the avatar is hidden or the translucent avatar is displayed, the world view and the sense of presence in the space where the avatar exists are impaired.

Due to the above circumstances, there is a demand for a technique capable of securing or maintaining the visual recognition of a user with respect to the space where the avatar exists while maintaining the world view or the sense of presence of the space where the avatar exists.

### Means for Solving the Problems

One of representative embodiments of the present invention is an information processing apparatus configured to cause a user to feel a space where an avatar exists, the information processing apparatus including: a display connected to a server configured to provide at least a part of the space via a network and configured to display an image for expressing the space based on information received from the server, wherein the information processing apparatus is configured to execute, in cooperation with the server, region setting processing of setting a first region in which a first user who uses the information processing apparatus is considered to be interested in the image displayed on the display; avatar specifying processing of specifying, in the image displayed on the display, a first avatar different from an image of interest that is an image in which the first user is considered to be interested, based on a positional relationship with the first region; and avatar display control processing of controlling display of the first avatar such that the first avatar is entirely displayed outside the first region.

One of representative embodiments of the present invention is an information processing system configured to cause a user to feel a space where an avatar exists, the information processing system including a server configured to provide at least a part of the space and an information processing apparatus connected to the server via a network, the information processing apparatus including a display configured to display an image for expressing the space based on information received from the server, wherein the information processing apparatus is configured to execute, in cooperation with the server, region setting processing of setting a first region in which a first user who uses the information processing apparatus is considered to be interested in the image displayed on the display; avatar specifying processing of specifying, in the image displayed on the display, a first avatar different from an image of interest that is an image in which the first user is considered to be interested, based on a positional relationship with the first region; and avatar display control processing of controlling display of the first avatar such that the first avatar is entirely displayed outside the first region.

One of representative embodiments of the present invention is an information processing method of causing a user to feel a space where an avatar exists, wherein an information processing apparatus, including a display connected to a server configured to provide at least a part of the space via a network and configured to display an image for expressing the space based on information received from the server, is configured to, in cooperation with the server, set a first region in which a first user who uses the information processing apparatus is considered to be interested in the image displayed on the display, specify, in the image displayed on the display, a first avatar different from an image of interest that is an image in which the first user is considered to be interested, based on a positional relationship with the first region, and control display of the first avatar such that the first avatar is entirely displayed outside the first region.

### Effects of the Invention

According to the representative embodiment of the present invention, it is possible to secure or maintain the visual recognition of the user with respect to the space where the avatar exists while maintaining the world view or the sense of presence of the space where the avatar exists.

### BRIEF DESCRIPTIONS OF THE DRAWINGS

FIG. 1 is a diagram schematically illustrating an example of a hardware configuration of an information processing system.

FIG. 2 is a diagram illustrating a specific example of an information processing apparatus.

FIG. 3 is a diagram conceptually illustrating an example of a hardware configuration of the information processing system.

FIG. 4 is a diagram illustrating an example of a functional block configuration of the information processing apparatus.

FIG. 5 is a table illustrating an example of a region-of-interest setting start condition.

FIG. 6 is a table illustrating an example of a region-of-interest setting method.

FIG. 7 is a diagram illustrating an example of a region of interest set in an avatar existence space image.

FIG. 8 is a diagram illustrating an example of the region of interest set in the avatar existence space image.

FIG. 9 is a diagram illustrating an example of the region of interest set in the avatar existence space image.

FIG. 10 is a diagram illustrating an example of the region of interest set in the avatar existence space image.

FIG. 11 is a table illustrating an example of an avatar display control start condition.

FIG. 12 is a table illustrating an example of setting of whether or not to execute avatar display control according to a relationship between an avatar different from an image of interest and a user or an avatar used by the user.

FIG. 13 is a table illustrating an example of avatar display control processing.

FIG. 14 is a table illustrating an example of an avatar display control release condition.

FIG. 15 is a diagram illustrating a primary example of a processing flow of the information processing system.

FIG. 16 is a diagram illustrating a secondary example of the processing flow of the information processing system.

FIG. 17 is a diagram for describing a first example of the avatar display control.

FIG. 18 is a diagram for describing the first example of the avatar display control.

FIG. 19 is a diagram for describing the first example of the avatar display control.

FIG. 20 is a diagram for describing the first example of the avatar display control. FIG. 21 is a diagram for describing the first example of the avatar display control.

FIG. 22 is a diagram for describing the first example of the avatar display control.

FIG. 23 is a diagram for describing the first example of the avatar display control.

FIG. 24 is a diagram for describing a second example of the avatar display control.

FIG. 25 is a diagram for describing a third example of the avatar display control.

FIG. 26 is a diagram for describing the third example of the avatar display control.

FIG. 27 is a diagram for describing a fourth example of the avatar display control.

FIG. 28 is a diagram for describing the fourth example of the avatar display control.

FIG. 29 is a diagram for describing a fifth example of the avatar display control.

FIG. 30 is a diagram for describing the fifth example of the avatar display control.

FIG. 31 is a diagram for describing a sixth example of the avatar display control.

FIG. 32 is a diagram for describing the sixth example of the avatar display control.

FIG. 33 is a diagram for describing a seventh example of the avatar display control.

FIG. 34 is a diagram for describing the seventh example of the avatar display control.

FIG. 35 is a diagram for describing an eighth example of the avatar display control.

FIG. 36 is a diagram for describing the eighth example of the avatar display control.

FIG. 37 is a diagram for describing a ninth example of the avatar display control.

FIG. 38 is a diagram for describing the ninth example of the avatar display control.

FIG. 39 is a table for describing the ninth example of the avatar display control.

FIG. 40 is a table for describing a tenth example of the avatar display control.

FIG. 41 is a diagram illustrating an example not executing the avatar display control based on a relationship between a display control target candidate avatar and a user or an avatar used by the user.

### DETAILED DESCRIPTION OF PREFERRED EMBODIMENTS

Hereinafter, an embodiment of the present invention will be described with reference to the drawings. Note that, in each embodiments and drawing, the same or equivalent components are denoted by the same numbers or reference numerals, and repetitive description will be omitted unless otherwise specified.

An information processing system according to an embodiment of the present invention will be described in detail with reference to the drawings.

### <Outline of Information Processing System>

The information processing system causes a display of an information processing apparatus used by a user to display an image for expressing a space (hereinafter, also referred to as an avatar existence space) where an avatar exists, thereby allowing the user to feel the avatar existence space through the image. The avatar existence space is, for example, a space representing virtual reality, augmented reality, or mixed reality. The information processing system sets a region (hereinafter, also referred to as a region of interest) in which the user is considered to be interested in the avatar existence space. Further, the information processing system controls the display of the avatar such that the entire avatar different from the image (hereinafter, also referred to as an image of interest) in which the user is considered to be interested is displayed outside the region of interest.

That is, the information processing system changes the display position and the display shape of the avatar that may be an obstacle to the visual recognition when the user visually recognizes the image in which the user is interested, that is, pays attention, in the avatar existence space, and suppresses the obstacle to the visual recognition. In the information processing system, the avatar that may be an obstacle to the visual recognition of the image in which the user is interested is not temporarily hidden or made translucent. Therefore, the unnaturalness is greatly suppressed in the display of the avatar, and thus it is possible to secure or maintain the visual recognition of the user with respect to the space where the avatar exists while maintaining the world view or the sense of presence of the space where the avatar exists.

### <Hardware Configuration of Information Processing System>

FIG. 1 is a diagram schematically illustrating an example of a hardware configuration of an information processing system. As illustrated in FIG. 1, an information processing system 1000 includes a server 1 and an information processing apparatus 3 connected to the server 1 via a network 2. In addition, one or more other information processing apparatuses 4 connected to the server 1 via the network 2 and including a display as a display may be further included. In addition, another information processing apparatus 4 may have the same configuration as the information processing apparatus 3. In a case where the information processing apparatus 3 is connected to the server 1, a situation in which a user 5 uses the information processing apparatus 3 is assumed. In addition, in a case where the information processing apparatus 3 and another information processing apparatus 4 are connected to the server 1, a situation in which the user 5 and another user 6 use the information processing apparatus 3 or the another information processing apparatus 4, respectively, is assumed. Note that the “information processing apparatus” may be considered to be an example of a “first information processing apparatus” in the present invention, and the “another information processing apparatus” may be considered to be an example of a “second information processing apparatus” in the present invention. In addition, the “user” may be considered to be an example of a “first user” in the present invention, and the “another user” may be considered to be an example of a “second user” in the present invention.

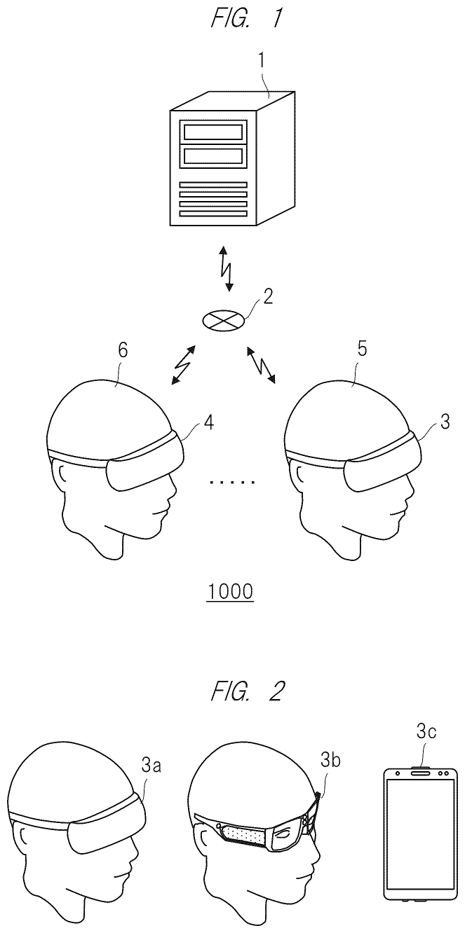

FIG. 2 is a diagram illustrating a specific example of an information processing apparatus. The information processing apparatus 3 includes a display as a display, and is, for example, a video see-through type head-mounted display (HMD) 3a, an optical see-through type head-mounted display 3b, or an information portable terminal 3c such as a smartphone or a tablet terminal as illustrated in FIG. 2.

FIG. 3 is a diagram conceptually illustrating an example of a hardware configuration of the information processing system 1000. The server 1 provides a space representing virtual reality, augmented reality, or mixed reality. Specifically, the server 1 transmits data for displaying an image representing a part or the whole of the avatar existence space to the information processing apparatus 3 connected to the server 1. The data is designed such that an image is displayed on the display of the information processing apparatus 3 based on the data, and the user 5 can visually recognize or feel the avatar existence space when viewing the image through the display. There is usually a plurality of avatars in the space provided by the server 1. The plurality of avatars may correspond to the user 5 of the information processing apparatus 3 connected to the server 1 or a double of the another user 6 who uses the another information processing apparatus 4, correspond to a fictitious person generated by the server 1, or a mixture thereof.

The network 2 is a communication network that connects the server 1 and the information processing apparatus 3, and is, for example, the Internet or a local area network (LAN).

The information processing apparatus 3 is connected to the server 1 via the network 2. The information processing apparatus 3 displays an image representing a part of the whole of the avatar existence space on its display based on the data received from the server 1. As described above, the user 5 can visually recognize or feel the avatar existence space by viewing the image through the display on which the image is displayed.

In addition, the information processing apparatus 3 has a function of controlling display of at least a part of the avatar existing in the avatar existence space. The information processing apparatus 3 specifies an image of interest that is an image representing an object, avatar, real object, or the like that the user 5 is considered to be interested in the avatar existence space. The image of interest is specified, for example, based on a detection result of the position of the viewpoint (line of sight) of the user 5 in an image region of the image displayed on the display of the information processing apparatus 3 and the operation of selecting the image by the user 5. Among the avatars that the user 5 is considered not to be interested in, the information processing apparatus 3 specifies an avatar that may be an obstacle to the visual recognition of the image of interest as an avatar that is a target of display control (hereinafter, also referred to as a display control target avatar). The information processing apparatus 3 controls display of a part or the whole of the display control target avatar such that the entire display control target avatar is displayed outside the region of interest including the image of interest. Note that the “display control target avatar” is an example of a “first avatar” in the present invention.

By such display control (hereinafter, also referred to as avatar display control) of the display control target avatar by the information processing apparatus 3, it is possible to secure or maintain the visual recognition of the user 5 with respect to the avatar existence space while maintaining the world view or the sense of presence of the avatar existence space. Details of the avatar display control will be described below.

An example of a configuration of the information processing apparatus 3 will be described. As illustrated in FIG. 3, the information processing apparatus 3 includes a communication bus 301, a rear camera 302, a front camera 303, a ranging sensor 304, an acceleration sensor 305, a gyro sensor 306, a geomagnetic sensor 307, a positioning sensor 308, and a network transceiver 309. The information processing apparatus 3 further includes a display 311, a microphone 312, a loud speaker 313, a timer 314, a processor 315, an operation unit 316, and a memory 317.

The communication bus 301 is connected to each element from the rear camera 302 to the memory 317, and enables data communication between the elements.

The rear camera 302 is a camera that captures an image on the back side of the display surface of the display 311, that is, on the side opposite to the display surface, and outputs data representing the image obtained by the imaging. The rear camera 302 is configured so that the user 5 who uses the information processing apparatus 3 can capture an image that would otherwise be visually recognized without the information processing apparatus 3.

The front camera 303 is a camera that captures an image on the front side of the display surface of the display 311, that is, on the side facing the display surface, and outputs data representing the image obtained by the imaging. In a case where the information processing apparatus 3 is a head-mounted display, the front camera 303 is configured to be able to capture an image of an eye of the user 5 who uses the information processing apparatus 3. In a case where the information processing apparatus 3 is an information portable terminal, the front camera 303 is configured to be able to capture an image of at least a part of the body including the eye of the user 5 who uses the information processing apparatus 3.

Accordingly, the movement of the eye, that is, the movement of the line of sight of the user 5 is reflected in the data output by the imaging from the front camera 303. By analyzing the data output from the front camera 303, the position of the viewpoint of the user 5 in the image region of the image displayed on the display 311 can be detected. For example, a generally known eye tracking technique can be used to detect the position of the viewpoint of the user 5. In addition, for example, an eye tracking device can be used to detect the position of the viewpoint of the user 5.

The ranging sensor 304 is a sensor that enables measurement of the distance from the reference position of the information processing apparatus 3 and is capable of detecting the relative position of the information processing apparatus 3.

The acceleration sensor 305 is a sensor that enables measurement of accelerations of the information processing apparatus 3 in three axial directions orthogonal to one another and is capable of detecting movement of the information processing apparatus 3.

The gyro sensor 306 is a sensor that enable measurement of the inclination from the reference state of the information processing apparatus 3 and is capable of detecting the inclination of the posture of the information processing apparatus 3.

The geomagnetic sensor 307 is a sensor that enables measurement of geomagnetism at a position where the information processing apparatus 3 exists and is capable of detecting which direction: east, west, north, and south the information processing apparatus 3 is facing.

The positioning sensor 308 is, for example, a global positioning system (GPS). It is possible to detect at which coordinates on the earth the information processing apparatus 3 is located by communication with a GPS satellite. In addition, as another example, the rear camera or the ranging sensor may be used as the positioning sensor. A current position can be obtained by analyzing an image captured by the rear camera or three-dimensional point cloud data measured by the ranging sensor, and techniques such as visual positioning service (VPS) and simultaneous localization and mapping (SLAM) are known. In addition, the geomagnetic sensor, the acceleration sensor, and the gyro sensor may be used as the positioning sensor. A current position can be obtained as a relative position from a reference position, and techniques such as pedestrian dead reckoning (PDR) are known. In addition, positioning may be performed using wireless communication. A current position can be obtained by performing three-point positioning by detecting a difference in strength and arrival time of each electric wave from a plurality of wireless communication access points.

The network transceiver 309 is a transceiver for connecting the information processing apparatus 3 to the network 2. Communication by the network transceiver 309 may be wired or wireless.

The display 311 displays an image for expressing a space where the avatar exists. a case where the information processing apparatus 3 is a video see-through type head-mounted display or a portable information terminal, an image based on data received from the server 1 is displayed on the display 311. Alternatively, a composite image obtained by combining an image based on data output by imaging from the rear camera 302 and an image based on data received from the server 1 is displayed on the display 311. In this case, the display 311 is, for example, a liquid crystal panel, an organic electroluminescence (EL) panel, or the like.

In a case where the information processing apparatus 3 is an optical see-through type head-mounted display, an image based on data received from the server 1 is displayed on the display 311. In this case, the display 311 is a transmissive liquid crystal panel or the like.

Note that, in a case where the display of a target avatar is controlled in the information processing apparatus 3, the target avatar whose position or form has been controlled is displayed on the display 311.

The microphone 312 collects ambient sound, a voice uttered by the user 5, and the like, converts them into an electrical signal, and outputs the electrical signal.

The loud speaker 313 receives input of a sound signal representing a sound heard in the avatar existence space, a sound collected by the microphone, a voice uttered by the user 6 of another information processing apparatus 4 connected to the server 1, and the like, and outputs a sound based on the input sound signal.

The timer 314 has a clock function, and outputs a signal indicating a current time or outputs a signal indicating that a set time has elapsed when the set time has elapsed.

Note that various states regarding the user 5 can be grasped by comprehensively analyzing the each output of the rear camera 302, the front camera 303, the ranging sensor 304, the acceleration sensor 305, the gyro sensor 306, and the geomagnetic sensor 307. The state of the user 5 is, for example, a place, an orientation, a posture, a movement of a body, a movement of an eye, that is, a line of sight or a viewpoint, or the like of the user 5.

The processor 315 is, for example, a central processing unit (CPU), a microprocessor unit (MPU), a microcontroller unit (MCU), or the like.

In addition, the processor 315 comprehensively processes outputs of the rear camera 302, the front camera 303, the ranging sensor 304, the acceleration sensor 305, the gyro sensor 306, the geomagnetic sensor 307, the positioning sensor 308, the microphone 312, and the timer 314. In addition, the processor 315 recognizes the state of the user 5 such as the place, the orientation, the posture, the movement, the voice, the scene as it would appear to the user 5, the image that the user 5 is gazing, and the like based on a result of the processing. Then, the processor 315 causes the display screen of the display 311 to display an image for representing the avatar existence space reflecting the recognized state of the user 5, and causes the loud speaker 313 to output a sound in the avatar existence space, thereby allowing the user 5 to feel the avatar existence space.

The operation unit 316 receives an input operation by the user 5. The operation unit 316 receives, for example, an operation for designating a position in an image displayed on the display 311 or inputting information necessary for various settings. The operation unit 316 receives input corresponding to an intention Of the user 5 such as designation, setting, selection, and decision in accordance with an operation from the user 5. The operation unit 316 is, for example, a device such as a touch panel, a button, a trackball, or a joystick.

The memory 317 stores one or a plurality of programs 318, various data 319, and the like. The processor 315 functions as various functional blocks described below by reading the program 318, loading the program to the memory 317, and executing the program. The memory 317 is, for example, a semiconductor storage apparatus, an optical disk storage apparatus, a magnetic disk storage apparatus, or the like.

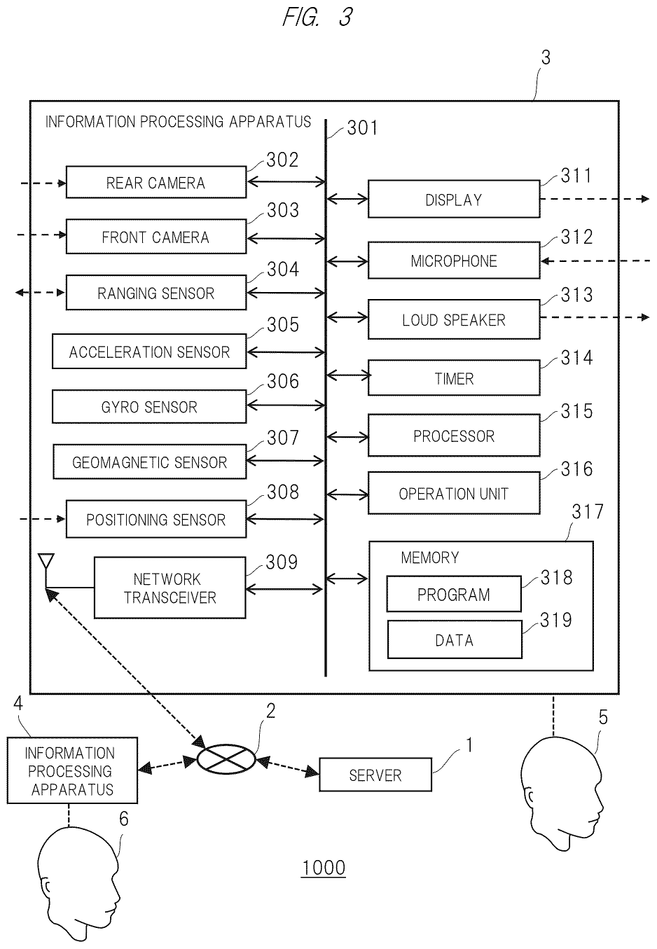

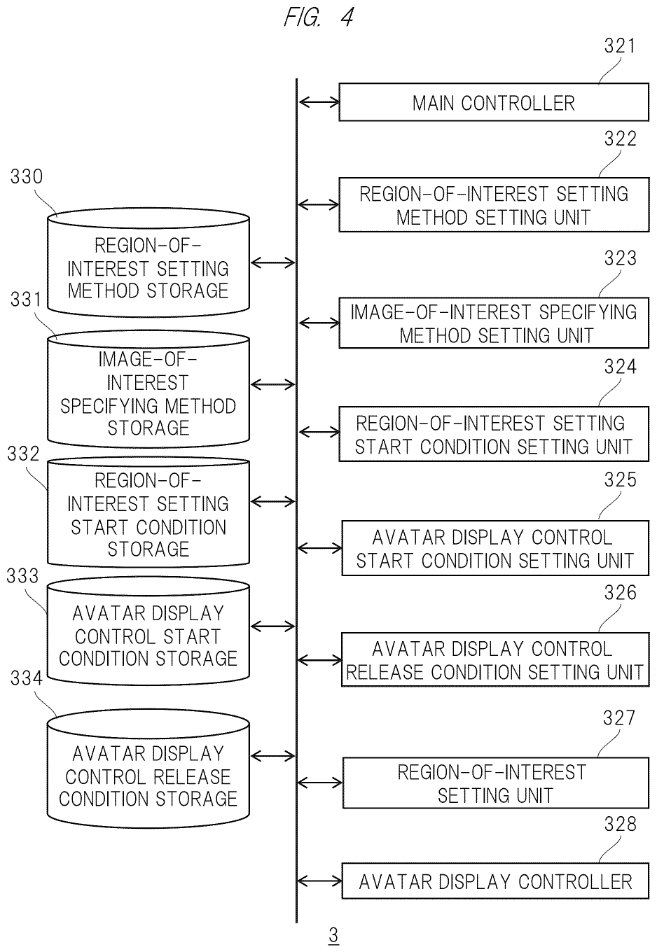

FIG. 4 is a diagram illustrating an example of a functional block configuration of the information processing apparatus 3. The information processing apparatus 3 includes, as functional blocks, a main controller 321, a region-of-interest setting method setting unit 322, an image-of-interest specifying method setting unit 323, a region-of-interest setting start condition setting unit 324, an avatar display control start condition setting unit 325, an avatar display control release condition setting unit 326, a region-of-interest setting unit 327, and an avatar display controller 328. The information processing apparatus 3 further includes, as functional blocks, a region-of-interest setting method storage 330, an image-of-interest specifying method storage 331, a region-of-interest setting start condition storage 332, an avatar display control start condition storage 333, and an avatar display control release condition storage 334.

The main controller 321 sends commands to various functional blocks to control these functional blocks, and executes various types of processing including sensing processing, determination processing, and the like.

The region-of-interest setting start condition setting unit 324 executes processing of setting a region-of-interest setting start condition.

Here, the region of interest is a region in which the user 5 is considered to be interested in the avatar existence space image. In addition, the region-of-interest setting start condition refers to a condition for starting setting of a region of interest and, as necessary, an image of interest, and in a case where this condition is satisfied, processing of setting the region of interest and, as necessary, the image of interest is started. Note that the “region of interest” is an example of a “first region” in the present invention. Details of a method of setting the region of interest will be described below.

The region-of-interest setting start condition setting unit 324 sets the region-of-interest setting start condition based on a command for initial setting from the main controller 321, a command from the server 1, or an instruction from the user 5. The region-of-interest setting start condition setting unit 324 sets the region-of-interest Setting start condition by selecting one or more of a plurality of region-of-interest setting start conditions indicated by the information stored in the region-of-interest setting start condition storage 332.

The region-of-interest setting start condition storage 332 stores information indicating a plurality of region-of-interest setting start conditions. In addition to the information of a region-of-interest setting start condition table, information necessary for determining whether or not the region-of-interest setting start condition is appropriate and setting the region of interest or the image of interest is stored. Examples of the information necessary for determining whether or not the region-of-interest setting start condition is appropriate and setting the region of interest or the image of interest include viewpoint (line-of-sight) position information of the user 5 in the image region of the image displayed on the display 311 of the information processing apparatus 3, information regarding the movement amount of the viewpoint (line of sight) of the user 5 during a first duration, position information of the image designated by the user, and the like. In addition, needless to say, each piece of information may be information including a plurality of pieces of data. For example, the position information may be information including point cloud data.

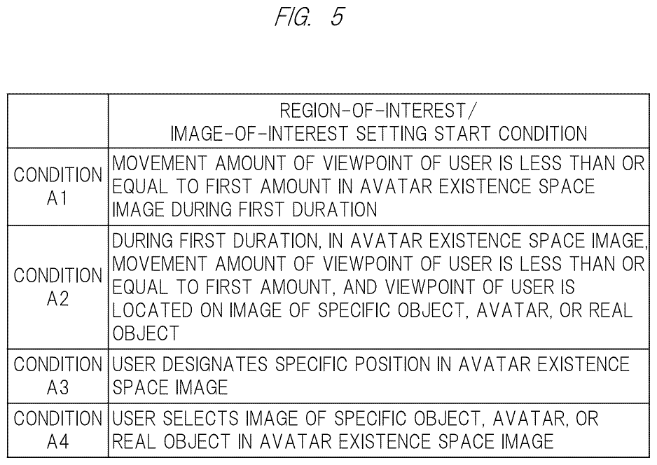

FIG. 5 is a table illustrating an example of the region-of-interest setting start condition. Examples of the region-of-interest setting start condition include Conditions A1 to A4 as illustrated in FIG. 5.

Condition A1 is that the movement amount of the viewpoint of the user 5 is less than or equal to a first amount in the avatar existence space image during the first duration. The first duration is, for example, 0.5 seconds to 2 seconds. The first amount is, for example, an amount corresponding to 2% to 10% of a longitudinal length of the space image. In general, the user 5 gazes at what the user 5 is interested in. According to such Condition A1, it is possible to sense a state in which the user 5 is considered to be gazing at an object the user 5 is interested in and to set the region of interest with the sensing as a trigger.

Condition A2 is that, during the first duration, in the avatar existence space image, the movement amount of the viewpoint of the user 5 is less than or equal to the first amount, and the viewpoint of the user 5 is on (overlaps) the image representing a specific object, avatar, or real object. According to such Condition A2, it is possible to sense a state in which the user 5 is considered to be gazing at the image the user 5 is interested in and to set the region of interest with the sensing as a trigger.

Condition A3 is that the user 5 designates a specific position in the avatar existence space image. According to such Condition A3, it is possible to cause the user 5 to designate the position of an object or region the user 5 is interested in and set the region of interest with the designation as a trigger.

Condition A4 is that the user 5 selects an image representing a specific object, avatar, or real object in the avatar existence space image. According to such Condition A4, it is possible to cause the user 5 to select the image the user 5 is interested in and set the region of interest with the selection as a trigger.

The region-of-interest setting method setting unit 322 executes processing of setting a region-of-interest setting method. Here, the region-of-interest setting method refers to a method of setting the region of interest and, as necessary, the image of interest in the avatar existence space image. The region-of-interest setting method setting unit 322 sets the region-of-interest setting method, for example, based on a command for initial setting from the main controller 321, a command from the server 1, or an instruction from the user 5. The region-of-interest setting method setting unit 322 sets the region-of-interest setting method by selecting a region-of-interest setting method from a plurality of region-of-interest setting methods indicated by information stored in the region-of-interest setting method storage 330.

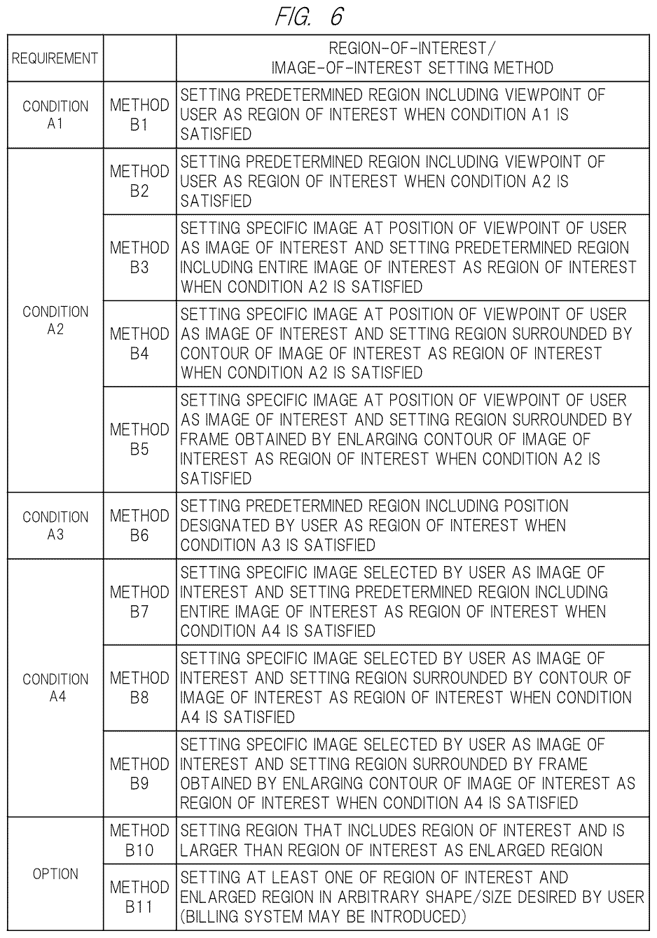

The region-of-interest setting method storage 330 stores information indicating a plurality of region-of-interest setting methods. In addition, examples of the region-of-interest setting method include methods illustrated in FIG. 6.

The image-of-interest specifying method setting unit 323 executes processing of setting an image-of-interest specifying method. Here, the image-of-interest specifying method refers to a method of specifying the image of interest in the avatar existence space image. The image-of-interest specifying method setting unit 323 sets the image-of-interest specifying method, for example, based on a command for initial setting from the main controller 321, a command from the server 1, or an instruction from the user 5. The image-of-interest specifying method setting unit 323 sets the image-of-interest specifying method by selecting an image-of-interest specifying method from a plurality of image-of-interest specifying methods indicated by information stored in the image-of-interest specifying method storage 331.

The image-of-interest specifying method storage 331 stores information indicating a plurality of image-of-interest specifying methods. In addition, examples of the image-of-interest specifying method include a method of detecting the position of the viewpoint (line of sight) of the user 5 in the image region of the image displayed on the display 311 of the information processing apparatus 3 or performing an operation of selecting a specific image by the user 5.

In addition, the image-of-interest specifying method setting unit 323 and the region-of-interest setting method setting unit 322, and the image-of-interest specifying method storage 331 and the region-of-interest setting method storage 330 may be integrated and configured.

FIG. 6 is a table illustrating an example of the region-of-interest setting method. In addition, FIGS. 7 to 10 are diagrams illustrating an example of the region of interest set in the avatar existence space image. Examples of the region-of-interest setting method include Methods B1 to B11 as illustrated in FIG. 6.

Method B1 is a method automatically set when Condition A1 is set. Method B1 is a method of setting a predetermined region including a viewpoint 11 of the user 5 as a region of interest 12 in an avatar existence space image 10 as illustrated in FIG. 7 when Condition A1 is satisfied.

In general, the user 5 puts a viewpoint on a region in which the user 5 is interested. Therefore, by such Method B1, a region in which the user 5 is considered to be interested can be set as the region of interest 12. Note that, as will be described in detail below, the avatar located only partially inside the region of interest 12 is an avatar that may be an obstacle to the visual recognition of the region of interest 12. Such an avatar is specified as display control target avatars 141, 142, and 143, and the display is controlled to be located outside of the region of interest 12.

Method B2 is a method that can be set on condition that Condition A2 is set. Method B2 is a method of setting a predetermined region including the viewpoint 11 of the user 5 as the region of interest 12 in the avatar existence space image 10 when Condition A2 is satisfied. In general, the user 5 gazes at a region in which the user 5 is interested. Therefore, by such Method B2, a region in which the user 5 is considered to be interested can be set as the region of interest 12.

Methods B3 to B5 are methods in which only any one of these methods can be set on condition that Condition A2 is set.

Method B3 is a method of setting an image representing a specific object, avatar, or real object at the position of the viewpoint 11 of the user 5 as an image of interest 13 and setting a predetermined region including the entire image of interest 13 as the region of interest 12 in the avatar existence space image 10 as illustrated in FIG. 8 when Condition A2 is satisfied. Note that the avatar located only partially inside the region of interest 12 is specified as a display control target avatar 144, and the display is controlled to be located outside of the region of interest 12.

In general, the user 5 gazes at an image in which the user 5 is interested. Therefore, by such Method B3, an image in which the user 5 is considered to be interested can be set as the image of interest 13. In addition, it is natural to consider that the predetermined region including the image of interest 13 is a region in which the user 5 is interested. Therefore, by such Method B3, a region in which the user 5 is considered to be interested can be set as the region of interest 12. Further, by such Method B3, it is possible to cope with the user 5 who wishes to set the predetermined region including the image of interest 13 as the region of interest 12.

Method B4 is a method of setting an image representing a specific object, avatar, or real object at the position of the viewpoint 11 of the user 5 as an image of interest 13 and setting a region surrounded by the contour of the image of interest 13 as the region of interest 12 in the avatar existence space image 10 when Condition A2 is satisfied.

By such Method B4, similarly to Method B3, an image in which the user 5 is considered to be interested can be set as the image of interest 13. In addition, it is natural to consider that the region surrounded by the contour of the image of interest 13 is a region in which the user 5 is interested. Therefore, by such Method B4, a region in which the user 5 is considered to be interested can be set as the region of interest 12. Further, it is possible to cope with the user 5 who wishes to set the region surrounded by the contour of the image of interest 13 as the region of interest 12.

Method B5 is a method of setting an image representing a specific object, avatar, or real object at the position of the viewpoint of the user 5 as an image of interest 13 and setting a region surrounded by a frame obtained by enlarging the contour of the image of interest 13 at a predetermined magnification as the region of interest 12 in the avatar existence space image 10 when Condition A2 is satisfied.

By such Method B5, similarly to Method B3, an image in which the user 5 is considered to be interested can be set as the image of interest 13. In addition, it is natural to consider that the region surrounded by the frame obtained by enlarging the contour of the image of interest 13 is a region in which the user 5 is interested. Therefore, by such Method B5, a region in which the user 5 is considered to be interested can be set as the region of interest 12. Further, it is possible to cope with the user 5 who wishes to set the region surrounded by the frame obtained by enlarging the contour of the image of interest 13 as the region of interest 12.

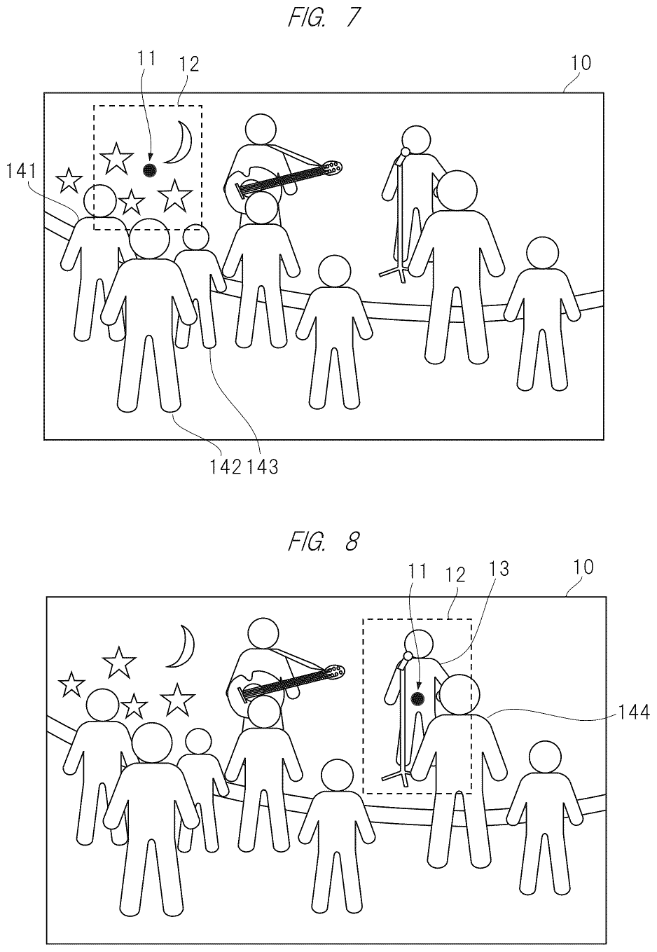

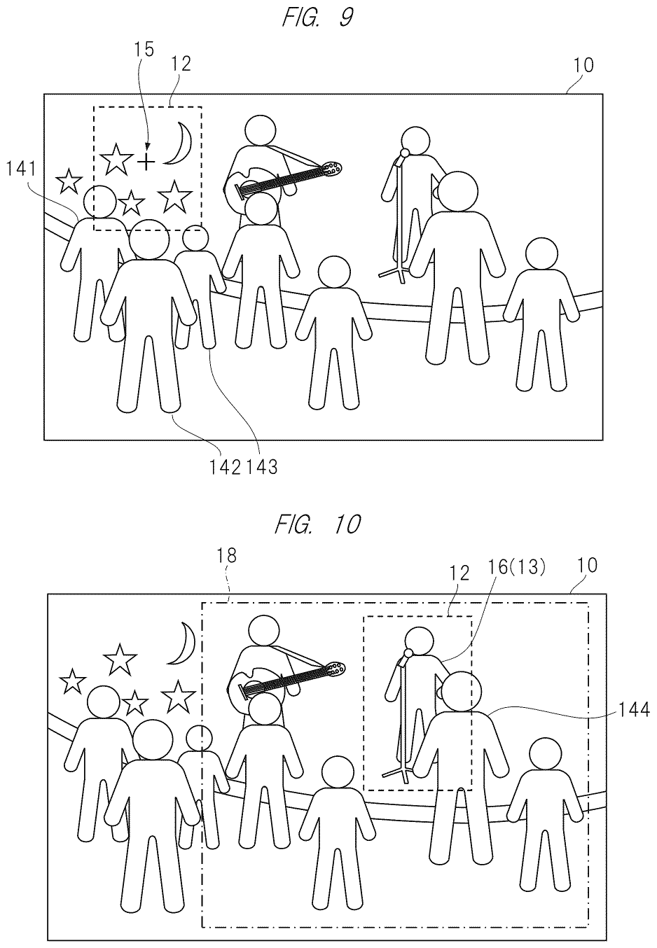

Method B6 is a method automatically set when Condition A3 is set. Method B6 is a method of setting a predetermined region including a designated position 15 designated by the user 5 as a region of interest 12 in the avatar existence space image 10 as illustrated in FIG. 9 when Condition A3 is satisfied. Note that the avatar located only partially inside the region of interest 12 is specified as display control target avatars 141, 142, and 143, and the display is controlled to be located outside of the region of interest 12.

Determining that the region including the designated position 15 is the region in which the user 5 is interested matches the sense of the user 5. Therefore, by such Method B6, a region in which the user 5 is considered to be interested can be set as the region of interest 12. Further, by such Method B6, it is possible to cope with the user 5 who wishes to set the region including the designated position 15 as the region of interest 12.

Methods B7 to B9 are methods in which only any one of these methods can be set on condition that Condition A4 is set.

Method B7 is a method of setting a specific image 16 representing a specific object, avatar, or real object selected by the user 5 as an image of interest 13 and setting a predetermined region including the entire image of interest 13 as the region of interest 12 as illustrated in FIG. 10 when Condition A4 is satisfied. Note that the avatar located only partially inside the region of interest 12 is specified as a display control target avatar 144, and the display is controlled to be located outside of the region of interest 12.

Determining that the specific image selected by the user 5 is the region in which the user 5 is interested matches the sense of the user 5. Therefore, by such Method B7, an image in which the user 5 is considered to be interested can be set as the image of interest. In addition, it is natural to consider that the predetermined region including the entire image of interest 13 is a region in which the user 5 is interested. Therefore, by such Method B7, a region in which the user 5 is considered to be interested can be set as the region of interest 12. Further, by such Method B7, it is possible to cope with the user 5 who wishes to set the region including the entire selected image as the region of interest 12.

Method B8 is a method of setting an image representing a specific object, avatar, or real object selected by the user 5 as an image of interest 13 and setting a region surrounded by the contour of the image of interest 13 as the region of interest 12 when Condition A4 is satisfied.

By such Method B8, similarly to Method B7, an image in which the user 5 is considered to be interested can be set as the image of interest 13. In addition, it is natural to consider that the region surrounded by the contour of the image of interest 13 is a region in which the user 5 is interested. Therefore, by such Method B8, a region in which the user 5 is considered to be interested can be set as the region of interest 12. Further, by such Method B8, it is possible to cope with the user 5 who wishes to set the region surrounded by the contour of the selected image as the region of interest 12.

Method B9 is a method of setting an image representing a specific object, avatar, or real object selected by the user 5 as an image of interest 13 and setting a region surrounded by a frame obtained by enlarging the contour of the image of interest 13 at a predetermined magnification as the region of interest 12 when Condition A4 is satisfied. The predetermined magnification is, for example, 1.5 times to 3 times.

By such Method B9, similarly to Method B7, an image in which the user 5 is considered to be interested can be set as the image of interest. In addition, it is natural to consider that the region surrounded by the frame obtained by enlarging the contour of the image of interest 13 is a region in which the user 5 is interested.

Therefore, by such Method B9, a region in which the user 5 is considered to be interested can be set as the region of interest 12. Further, by such Method B9, it is possible to cope with the user 5 who wishes to set the region surrounded by the frame obtained by enlarging the contour of the selected image as the region of interest 12.

Methods B10 to B11 are respectively methods set as additional options. Method B10 is a method of further setting a region that includes the region of interest 12 and is larger than the region of interest 12 as an enlarged region 18. The enlarged region 18 is used, for example, when controlling the display of the display control target avatar. In addition, the “enlarged region” is an example of a “second region” in the present invention, and may be considered to be a second region of interest.

By such method B10, the enlarged region 18 can be used as the second region used when the avatar display control is performed in a region larger than the region of interest 12, and variations of the avatar display control can be increased.

Method B11 is a method of setting at least one of the region of interest 12 and the enlarged region 18 in an arbitrary shape or size desired by the user 5. Note that the change in shape and size of the region of interest 12 or the enlarged region 18 may be permitted by payment of a charge from the user 5. In addition, the range in which the shape and size of the region of interest 12 or the enlarged region 18 can be changed may be limited or the limitation may be released according to the payment amount of the charge from the user 5.

By such Method B11, it is possible to set the region of interest 12 according to the preference of the user 5. In addition, by such Method B11, by introducing the charging system, it can be utilized as one of the business models.

Note that the predetermined region described above is, for example, a region having a predetermined size and a predetermined shape centered on the position of the viewpoint of the user 5 or the position designated by the user 5. The predetermined size is, for example, a size having an area corresponding to a predetermined proportion of the area of the image displayed on the display 311. The predetermined proportion is, for example, 0.5% to 2%. The predetermined shape is, for example, a polygonal shape, a rectangular shape, an elliptical shape, or a perfect circular shape. In addition, the predetermined region described above is, for example, a region having the same contour as the contour of the image representing the object, avatar, or real object designated or selected by the user 5, or a contour obtained by enlarging the contour of the image designated or selected by the user 5 at a predetermined magnification.

The avatar display control start condition setting unit 325 executes processing of setting an avatar display control start condition. Here, the avatar display control start condition refers to a condition for starting the display control of the display control target avatar, and in a case where this condition is satisfied, the processing of controlling the display of the display control target avatar is started. The avatar display control start condition setting unit 325 sets the avatar display control start condition based on a command for initial setting from the main controller 321, a command from the server 1, or an instruction from the user 5. The avatar display control start condition setting unit 325 sets the avatar display control start condition by selecting one or more of a plurality of avatar display control start conditions indicated by the information stored in the avatar display control start condition storage 333.

The avatar display control start condition storage 333 stores information indicating a plurality of avatar display control start conditions. In addition to the information of an avatar display control start condition table, information necessary for determining whether or not the avatar display control start condition is appropriate and performing the avatar display control is stored. Examples of the information necessary for determining whether or not the avatar display control start condition is appropriate and performing the avatar display control include position information of the region of interest 12 or the image of interest 13, position information of the enlarged region 18, position information of the avatar different from the image of interest 13, information regarding the moving direction of the avatar different from the image of interest 13, the information regarding the relationship between the avatar different from the image of interest 13 and the user 5 or the avatar used by the user 5, and the like. In addition, needless to say, each piece of information may be information including a plurality of pieces of data. For example, the position information may be information including point cloud data. As a result, the avatar display controller 328 can perform display control of a part of the display control target avatar different from the image of interest 13.

In addition, the region of interest 12 or the image of interest 13, and the enlarged region 18 are specified, for example, based on a detection result of the position of the viewpoint (line of sight) of the user 5 in the image region of the image displayed on the display 311 of the information processing apparatus 3 and the operation of selecting the image by the user 5, and their position information is stored. In addition, the position information of the avatar different from the image of interest 13 and the information regarding the moving direction of the avatar different from the image of interest 13 are acquired from the image displayed on the display 311 of the information processing apparatus 3 or the server 1, and the position information is stored.

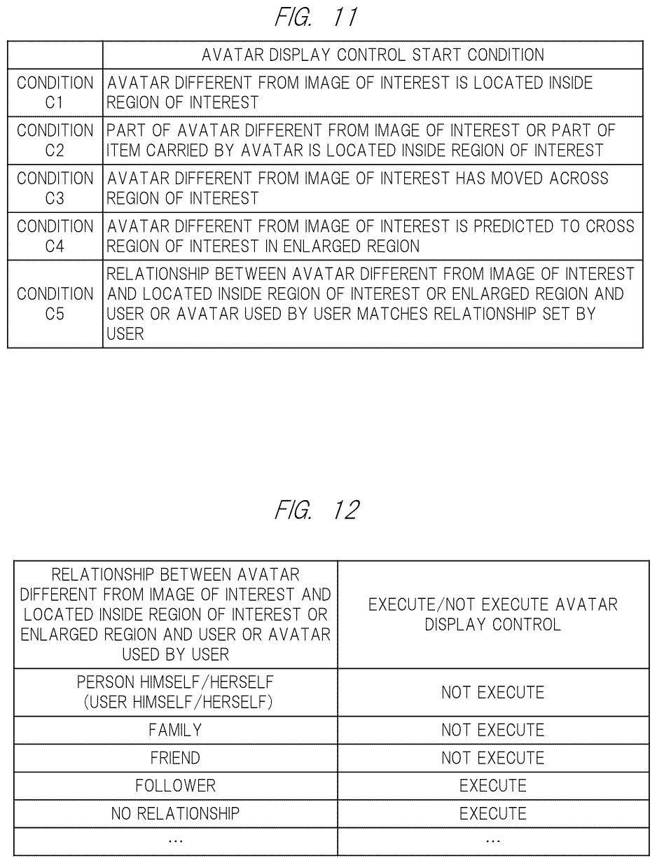

FIG. 11 is a table illustrating an example of the avatar display control start condition. Examples of the avatar display control start condition include Conditions C1 to C5 as illustrated in FIG. 11.

Condition C1 is that the avatar different from the image of interest 13 is located inside the region of interest 12 in the avatar existence space image 10. According to such Condition C1, it is possible to sense that there is an avatar that may be an obstacle to the visual recognition of the region of interest 12 by the user 5, and start the display control of the avatar.

Condition C2 is that, in the avatar existence space image 10, at least a part of the avatar different from the image of interest 13 or at least a part of an item carried by the avatar is located inside the region of interest 12. According to such Condition C2, it is possible to sense that there is a part of the avatar or a part of an item carried by the avatar that may be an obstacle to the visual recognition of the region of interest 12 by the user 5, and start the display control of the part.

Condition C3 is that the avatar different from the image of interest 13 has moved across the region of interest 12 in the avatar existence space image 10. According to such Condition C3, it is possible to sense the avatar that enters the region of interest 12 and may be an obstacle to the visual recognition of the region of interest 12 by the user 5, and start the display control of the avatar.

Condition C4 is that the avatar different from the image of interest 13 is predicted to cross the region of interest 12 in the enlarged region 18 in the avatar existence space image 10. According to such Condition C4, it is possible to sense the avatar that is predicted to enter the region of interest 12 and may be an obstacle to the visual recognition of the region of interest 12 by the user 5, and start the display control of the avatar.

Condition C5 is that the relationship between the avatar different from the image of interest 13 and located inside the region of interest or the enlarged region 18 and the user 5 or the avatar used by the user 5 matches the relationship set by the user 5 to execute the avatar display control. This Condition C5 is a condition set as an additional option. In a case where this Condition C5 is set, the avatar display control is started in a case where Condition C5 is satisfied and the set condition among Conditions C1 to C4 is satisfied.

Here, an example of the above-described relationship between the avatar different from the image of interest 13 and the user 5 or the avatar used by the user 5 is illustrated, and a setting example of executing/not executing the avatar display control according to the relationship will be described.

FIG. 12 is a table illustrating an example of setting whether or not to execute avatar display control according to a relationship between an avatar different from the image of interest 13 and the user 5 or an avatar used by the user 5. As illustrated in FIG. 12, examples of the relationship include relationships with the person himself/herself, with a family (families), with a friend (friends, acquaintances), and with a follower (a person who is set as a person to follow the user 5 on social media), and no relationship. In addition, as a setting example by the user 5 of executing/not executing the avatar display control, for example, the following setting can be considered as illustrated in FIG. 12.
(1) In a case where the relationship is with the person himself/herself (the user 5 himself/herself), the avatar display control is not executed.
(2) In a case where the relationship is with a family, the avatar display control is not executed.
(3) In a case where the relationship is with a friend, the avatar display control is not executed.
(4) In a case where the relationship is with a follower, the avatar display control is executed.
(5) In a case where the relationship is no relationship, the avatar display control is executed.

According to such Condition C5, for the avatar having a desired relationship with the user 5 himself/herself, even in a case where the avatar may be an obstacle to the visual recognition of the region of interest 12, the user 5 can give priority to other circumstances and select not to perform the display control. According to such Condition C5, it is possible to perform the avatar display control in consideration of the case where the user 5 communicates with the avatar to be subjected to the display control. For example, in a case where the avatar that may be an obstacle to the visual recognition of the region of interest 12 is the avatar of a close relative, the avatar can be made to exist at a natural position where it is easy to communicate. That is, according to Condition C5, it is possible to reduce the possibility of becoming an obstructive factor of communication due to the difference in recognition of the mutual position between the user 5 and the avatar to be subjected to the display control.

In a case where the set region-of-interest setting start condition is satisfied, the region-of-interest setting unit 327 executes processing of setting the region of interest 12 or setting the region of interest 12 and the image of interest 13 in the avatar existence space image 10 based on the information stored in the region-of-interest setting start condition storage 332 by using the set region-of-interest setting method.

When the set avatar display control start condition is satisfied, the avatar display controller 328 executes the avatar display control processing that is processing of specifying the display control target avatar and controlling the display of the specified display control target avatar based on the information stored in the avatar display control start condition storage 333. As the avatar display control processing, the avatar display controller 328 executes processing according to the condition under which the avatar display control is started.

Therefore, the avatar display controller 328 specifies a display control target avatar different from the image of interest 13 based on the information stored in the avatar display control start condition storage 333, and changes and displays the display control target avatar different from the image of interest 13 to a position according to the condition under which the avatar display control is started in the image region of the image displayed on the display 311 of the information processing apparatus 3.

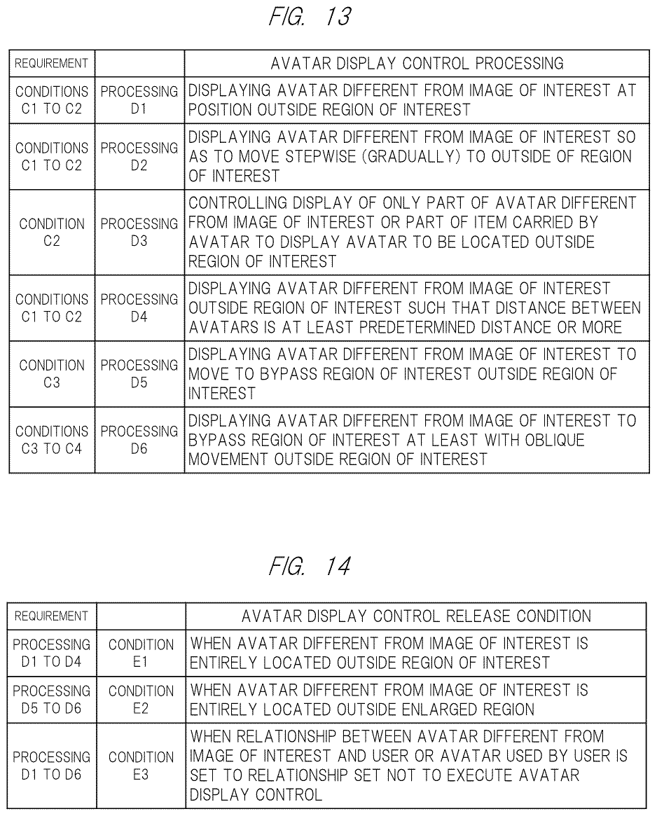

FIG. 13 is a table illustrating an example of the avatar display control processing.

As the avatar display control processing according to the condition under which the avatar display control is started, the avatar display controller 328 executes Processing D1 to D6 described below as illustrated, for example, in FIG. 13.

Processing D1 is processing in which, when Condition C1 or C2 is satisfied as the avatar display control start condition, the avatar different from the image of interest 13 and located at least partially inside the region of interest 12 is specified as the display control target avatar, and the entire display control target avatar is displayed so as to be located outside the region of interest 12. By such Processing D1, it is possible to display the avatar that may be an obstacle to the visual recognition of the region of interest 12 by the user 5 at a position that does not obstruct the visual recognition.

Processing D2 is processing in which, when Condition C1 or C2 is satisfied as the avatar display control start condition, the avatar different from the image of interest 13 and located at least partially inside the region of interest 12 is specified as the display control target avatar, and the entire display control target avatar is displayed so as to move gradually or stepwise outside the region of interest 12. By such Processing D2, the display position of the avatar that may be an obstacle to the visual recognition of the region of interest 12 by the user 5 can be moved at a speed that is not too fast, instead of being instantaneously changed, and the movement of the avatar can be made natural and it is possible to make it difficult for the user 5 to feel uncomfortable.

Processing D3 is processing in which, when Condition C2 is satisfied as the avatar display control start condition, at least a part of the avatar different from the image of interest 13 or at least a part of an item carried by the avatar located inside the region of interest 12 is displayed so as to be located outside the region of interest 12. In Processing D3, the display may be controlled only for the part, or the display may be controlled so that the form of the avatar changes. By such Processing D3, it is possible to suppress the size of the change amount of a portion changed by the display control to be small, and it is possible to make it difficult for the user 5 to feel uncomfortable. In addition, by Processing D3, the processing amount required for the avatar display control can be suppressed.

Processing D4 is processing in which, when Condition C1 or C2 is satisfied as the avatar display control start condition, the avatar different from the image of interest 13 and located at least partially inside the region of interest 12 is specified as the display control target avatar, and the display of the display control target avatar is controlled such that the display control target avatar is displayed outside the region of interest 12 and a distance d between the avatars is at least a predetermined distance d1 or more. Note that the distance d between the avatars may be a distance between representative center points of the avatars or a distance between image contours of the avatars. In addition, the predetermined distance d1 can be, for example, ⅓ of a representative longitudinal width of the avatar. By such Processing D4, it is possible to suppress the density of the avatars from being unnaturally increased, and it is possible to make it difficult for the user 5 to feel uncomfortable.

Processing D5 is processing in which, when Condition C3 or C4 is satisfied as the avatar display control start condition, the avatar different from the image of interest 13 and at least partially moving or predicted to move across the region of interest 12 is specified as the display control target avatar, and the display of the display control target avatar is controlled such that the display control target avatar moves to bypass or avoid the region of interest 12. By such Processing D5, it is possible to cause the avatar crossing or about to cross the region of interest 12 to move to bypass without stopping, and it is possible to make it difficult for the user 5 to feel uncomfortable.

Processing D6 is processing in which, when Condition C3 or C4 is satisfied as the avatar display control start condition, the avatar different from the image of interest 13 and at least partially moving or predicted to move across the region of interest 12 is specified as the display control target avatar, and the display of the display control target avatar is controlled such that the display control target avatar moves to bypass or avoid the region of interest 12 with an oblique movement. In Processing D6, when the display control target avatar is moved obliquely, the display of the display control target avatar may be controlled such that the orientation of the body of the display control target avatar faces the advancing direction. By such Processing D6, it is possible to cause the avatar crossing or about to cross the region of interest 12 to move to bypass without stopping, and it is possible to make it difficult for the user 5 to feel uncomfortable.

Note that these Processing D1 to D6 may be performed in combination with respect to a certain avatar display control start condition within a non-contradictory range.

The avatar display control release condition setting unit 326 sets an avatar display control release condition. The avatar display control release condition is a condition for releasing the avatar display control. When the set avatar display control release condition is satisfied, the avatar display control is released based on the information stored in the avatar display control release condition storage 334. The avatar display control release condition setting unit 326 sets one or a plurality of avatar display control start conditions represented by the information stored in the avatar display control release condition storage 334 as necessary.

The avatar display control release condition storage 334 stores information indicating one or a plurality of avatar display control release conditions. In addition to the information of an avatar display control release condition table, information necessary for determining whether or not the avatar display control release condition is appropriate and releasing the avatar display control is stored. Examples of the information necessary for determining whether or not the avatar display control release condition is appropriate and releasing the avatar display control include the position information of the region of interest 12 or the image of interest 13, the position information of the enlarged region 18, the position information of the avatar different from the image of interest 13, the information regarding the moving direction of the avatar different from the image interest 13, the information regarding the relationship between the avatar different from the image of interest 13 and the user 5 or the avatar used by the user 5, and the like. In addition, needless to say, each piece of information may be information including a plurality of pieces of data. For example, the position information may be information including point cloud data. As a result, it is possible to release the display control of a part of the display control target avatar different from the image of interest 13 performed by the avatar display controller 328.

In addition, the region of interest 12 or the image of interest 13, and the enlarged region 18 are specified, for example, based on a detection result of the position of the viewpoint (line of sight) of the user 5 in the image region of the image displayed on the display 311 of the information processing apparatus 3 and the operation of selecting the image by the user 5, and their position information is stored. In addition, the position information of the avatar different from the image of interest 13 and the information regarding the moving direction of the avatar different from the image of interest 13 are acquired from the image displayed on the display 311 of the information processing apparatus 3 or the server 1, and the position information is stored. In addition, the information stored in the avatar display control start condition storage 333 may be used as information necessary for determining whether or not the avatar display control release condition is appropriate and releasing the avatar display control.

FIG. 14 is a table illustrating an example of the avatar display control release condition. Examples of the avatar display control release condition include Conditions E1 to E3 as illustrated in FIG. 14.

Condition E1 is when the display control target avatar different from the image of interest 13 is located outside the region of interest 12, on condition that any of Processing D1 to D4 is performed. Condition E1 is a condition applied in a case where the avatar display control is intended to display the display control target avatar outside the region of interest 12.

Condition E2 is when the display control target avatar different from the image of interest 13 is located outside the enlarged region 18, on condition that any of Processing D5 to D6 is performed. This Condition E2 is a condition applied in a case where the avatar display control is intended to display the display control target avatar to bypass or avoid the region of interest 12.

Condition E3 is when the relationship between the display control target avatar different from the image of interest 13 and the user or the avatar used by the user 5 is set to the relationship set not to execute the avatar display control, on condition that any of Processing D1 to D6 is performed. This Condition E3 is a condition applied in a case where the avatar display control is intended to display the display control target avatar outside the region of interest 12 or to display the display control target avatar to bypass or avoid the region of interest 12.

### <Processing Flow of Information Processing System>

### «Primary Example»

The processing flow of the information processing system 1000 will be described below. Note that, here, it is assumed that the server 1 and the information processing apparatus 3 are already connected via the network 2. In addition, the processing in the information processing system 1000 is basically achieved by cooperation between the server 1 and the information processing apparatus 3.

First, a primary example of the processing flow of the information processing system will be described. This primary example is an example of a case where the processing related to the display control of the display control target avatar is performed on the information processing apparatus 3 side.

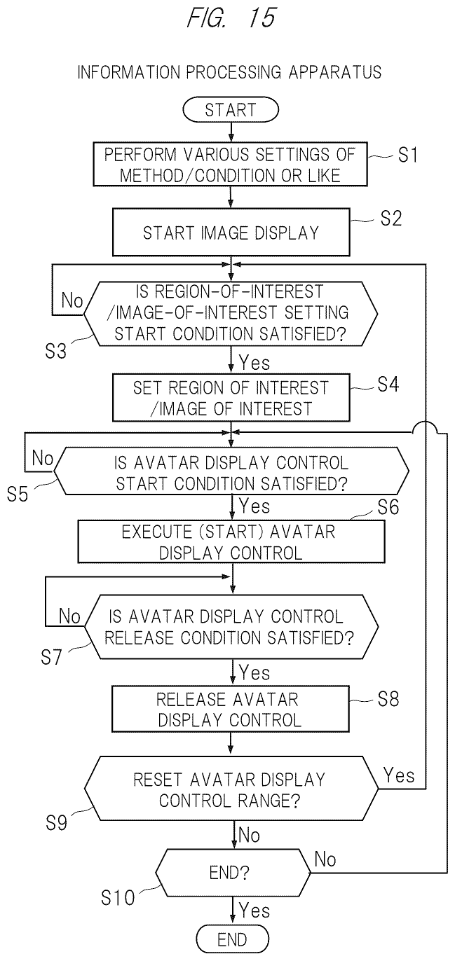

FIG. 15 is a diagram illustrating the primary example of the processing flow of the information processing system. As illustrated in FIG. 15, in Step S1, processing of performing various settings related to the avatar display control is performed. Specifically, the main controller 321 controls the region-of-interest setting method setting unit 322, the image-of-interest specifying method setting unit 323, the region-of-interest setting start condition setting unit 324, the avatar display control start condition setting unit 325, and the avatar display control release condition setting unit 326. By this control, these units execute processing, and the region-of-interest setting method, the image-of-interest specifying method, the region-of-interest setting start condition, the avatar display control start condition, and the avatar display control release condition are set.

In Step S2, processing of starting display of an image for expressing the avatar existence space image 10 is performed. Specifically, the main controller 321 displays a necessary image on the display screen of the display 311 based on the data received from the server 1 and the data acquired or generated by the information processing apparatus 3 so that the user 5 can visually recognize the avatar existence space image 10 through the display 311 of the information processing apparatus 3 used by the user 5.

In Step S3, processing of determining whether the region-of-interest setting start condition is satisfied is performed. Specifically, the main controller 321 determines whether any of the set region-of-interest setting start conditions is satisfied based on the information stored in the region-of-interest setting start condition storage 332. In a case where the main controller 321 determines that the region-of-interest setting start condition is satisfied (S3: Yes), the processing step proceeds to Step S4. On the other hand, in a case where the main controller 321 determines that the region-of-interest setting start condition is not satisfied (S3: No), the processing step returns to Step S3.

In Step S4, processing of setting the region of interest 12 is performed. Specifically, the region-of-interest setting unit sets the region of interest 12 in the avatar existence space image 10 based on the information stored in the region-of-interest setting start condition storage 332 by receiving the control from the main controller 321 and using the set region-of-interest setting method. At this time, the region-of-interest setting unit 327 also sets the image of interest 13 as necessary.

In Step S5, processing of determining whether the avatar display control start condition is satisfied is performed. Specifically, the main controller 321 determines whether any of the set avatar display control start conditions is satisfied based on the information stored in the avatar display control start condition storage 333. In a case where the main controller 321 determines that the avatar display control start condition is satisfied (S5: Yes), the processing step proceeds to Step S6. On the other hand, in a case where the main controller 321 determines that the avatar display control start condition is not satisfied (S5: No), the processing step returns to Step S5.

In Step S6, processing of starting the avatar display control is performed. Specifically, the avatar display controller 328 specifies the display control target avatar based on the information stored in the avatar display control start condition storage 333, and starts the display control of the display control target avatar.

In Step S7, processing of determining whether the avatar display control release condition is satisfied is performed. Specifically, the main controller 321 determines whether the set avatar display control release condition is satisfied based on the information stored in the avatar display control release condition storage 334. In a case where the main controller 321 determines that the avatar display control release condition is satisfied (S7: Yes), the processing step proceeds to Step S8. On the other hand, in a case where the main controller 321 determines that the avatar display control release condition is not satisfied (S7: No), the processing step returns to Step S7.

In Step S8, processing of releasing the avatar display control is performed. Specifically, the main controller 321 releases the avatar display control based on the information stored in the avatar display control release condition storage 334.

In Step S9, processing of determining whether or not to reset the region of interest 12 is performed. Specifically, the main controller 321 determines whether or not to reset the region of interest 12 based on a command from the server 1 or an instruction from the user 5. In a case where the main controller 321 determines to reset the region of interest 12, the processing step returns to Step S3. On the other hand, in a case where the main controller 321 determines not to reset the region of interest 12, the processing step proceeds to Step S10.

In Step S10, processing of determining whether or not to end the processing related to the avatar display control is performed. Specifically, the main controller 321 determines whether or not to end the processing related to the avatar display control based on the presence or absence of an operation error of the information processing apparatus 3, the on/off state of the image display for expressing the avatar existence space image 10, an instruction from the user 5, and the like. In a case c where the main controller 321 determines to end the processing related to the avatar display control (S10: Yes), the processing ends. On the other hand, in a case where the main controller 321 determines not to end the processing related to the avatar display control (S10: No), the processing step returns to Step S5, and the processing related to the avatar display control continues while the set region of interest 12 is maintained.

According to the primary example of the processing flow in the information processing system 1000 described above, since the content of the avatar display control is generated on the information processing apparatus 3 side, the load on the server 1 is reduced, the data transfer amount between the server 1 and the information processing apparatus 3 is also reduced, and the avatar display control can be performed at high speed. In addition, it is possible to ensure or maintain visual recognition with respect to a region in which the user 5 is considered to be interested, together with the world view and the sense of presence of the avatar existence space.

### «Secondary Example»

Next, a secondary example of the processing flow of the information processing system 1000 will be described. This secondary example is an example of a case where at least a part of the processing related to the display control of the display control target avatar is performed on the server 1 side. In addition, here, it may be considered that the server 1 includes at least a processor, a memory, and a configuration similar to the functional block configuration illustrated in FIG. 4.

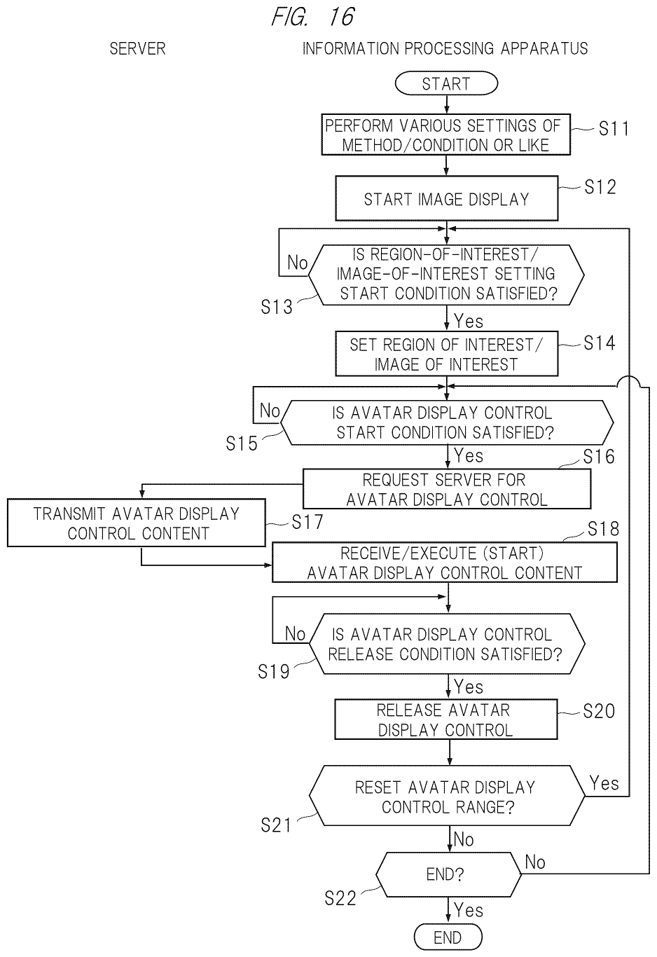

FIG. 16 is a diagram illustrating the secondary example of the processing flow of the information processing system. As illustrated in FIG. 16, the processing flow of the secondary example includes Steps S11 to S22. Steps S11 to S15 and S19 to S22 in the processing flow of the secondary example correspond to S1 to S5 and S7 to S9 in the processing flow of the primary example. That is, S16 to S18 in the processing flow of the secondary example are characteristic portions in the processing flow of the secondary example. Therefore, here, the description of Steps S11 to S15 and S19 to S22 is omitted, and only Steps S16 to S18 will be described.

In Step S16, processing of requesting the server for the avatar display control is performed on the information processing apparatus 3 side. Specifically, the main controller 321 of the information processing apparatus 3 transmits a signal for requesting the avatar display control to the server 1.

In Step S17, processing of transmitting the content of the avatar display control to the information processing apparatus 3 that has requested the avatar display control is performed on the server side. Specifically, the server 1 receives the request of the information processing apparatus 3 by communication with the information processing apparatus 3 connected via the network 2, and specifies the display control target avatar with respect to the user 5 in the avatar existence space image expressed in the information processing apparatus 3. In addition, the server 1 determines the content of the avatar display control with respect to the specified display control target avatar, and returns information indicating the content of the determined avatar display control to the information processing apparatus 3.

In Step S18, processing of receiving the content of the avatar display control from the server side and executing the avatar display control is performed on the information processing apparatus 3 side. Specifically, the main controller 321 receives information indicating the content of the avatar display control from the server 1 by communication with the server 1 connected via the network 2. The avatar display controller 328 controls the display of the display control target avatar based on the received information indicating the content of the avatar display control.

According to the secondary example of the processing flow in the information processing system 1000, since the content of the avatar display control is determined on the server 1 side and the content is sent to the information processing apparatus 3, the processing amount, that is, the load of the information processing apparatus 3 can be reduced.

### <Examples of Avatar Display Control>

Hereinafter, a more specific example of the avatar display control achieved by the information processing system 1000 will be described.

### (First Example)

A first example is an example of controlling the display of the avatar such that, among the avatars different from the image of interest, the avatar at least partially located inside the region of interest 12 is located outside the region of interest 12.

FIGS. 17 to 23 are diagrams for describing the first example of the avatar display control. As illustrated in FIG. 17, it is assumed that the avatar existence space image 10 is displayed on the display screen of the display 311 of the information processing apparatus 3 such as a head-mounted display. In addition, it is assumed that the viewpoint 11 of the user 5 in the avatar existence space image 10 is detected based on the analysis result of the image including the eye of the user 5 captured by the front camera 303 of the information processing apparatus 3.

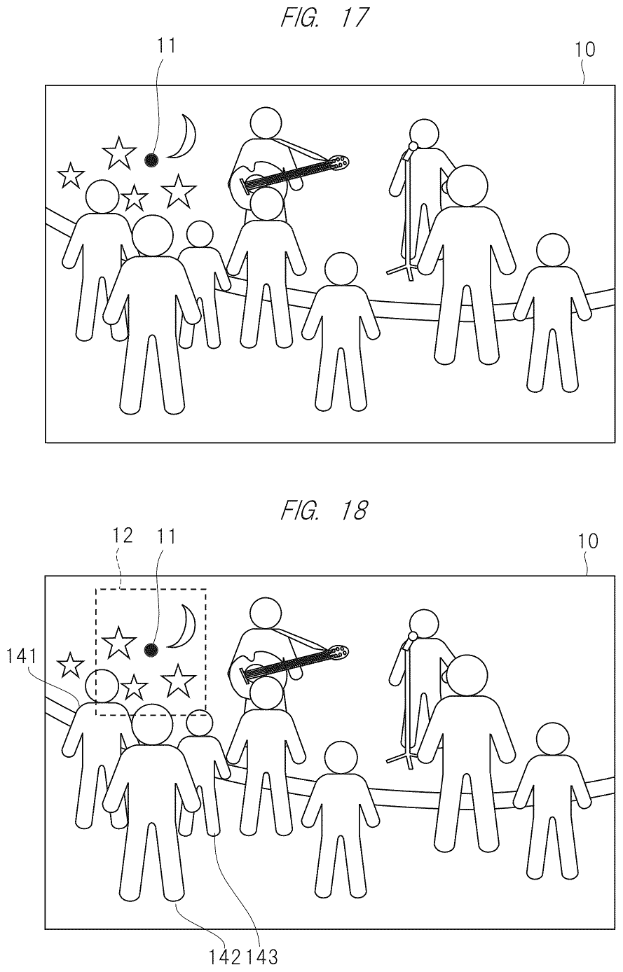

In a case where the movement amount of the viewpoint 11 of the user 5 is a predetermined amount or less for a predetermined time (first duration), a predetermined range including the viewpoint 11 of the user 5 is set as the region of interest 12 as illustrated in FIG. 18. In addition, when the region of interest 12 is set, an image representing a specific object, avatar, or real object entirely included inside the region of interest 12 is set as the image of interest 13. On the other hand, an object, avatar, or real object that is at least partially located outside the region of interest 12 is not set as the image of interest 13. Accordingly, there may be a case where no image of interest 13 is set.

When the region of interest 12 is set, in the avatar existence space image 10 expressed through the display 311 of the information processing apparatus 3, in a case where at least a part of the avatar different from the image of interest 13 is located inside the region of interest 12, the avatar is specified as the display control target avatars 141, 142, and 143. Then, as illustrated in FIG. 19, the display control target avatars 141, 142, and 143 are displayed so as to be entirely located outside the region of interest 12.

In general, the position and movement of the avatar in the avatar existence space image 10 are shared on the screen of the display 311 of each of the information processing apparatuses 3 used by all the users 5. However, in the present example, on the display screen of the display 311 of the information processing apparatus 3 used by a certain user 5, the avatar display control unique to the user 5, in other words, the avatar display control unique to the information processing apparatus 3 used by the user 5 is performed.

With such avatar display control, it is possible to ensure the world view and sense of presence of the avatar existence space while maintaining the visual recognition with respect to the region or image in which the user 5 is considered to be interested.

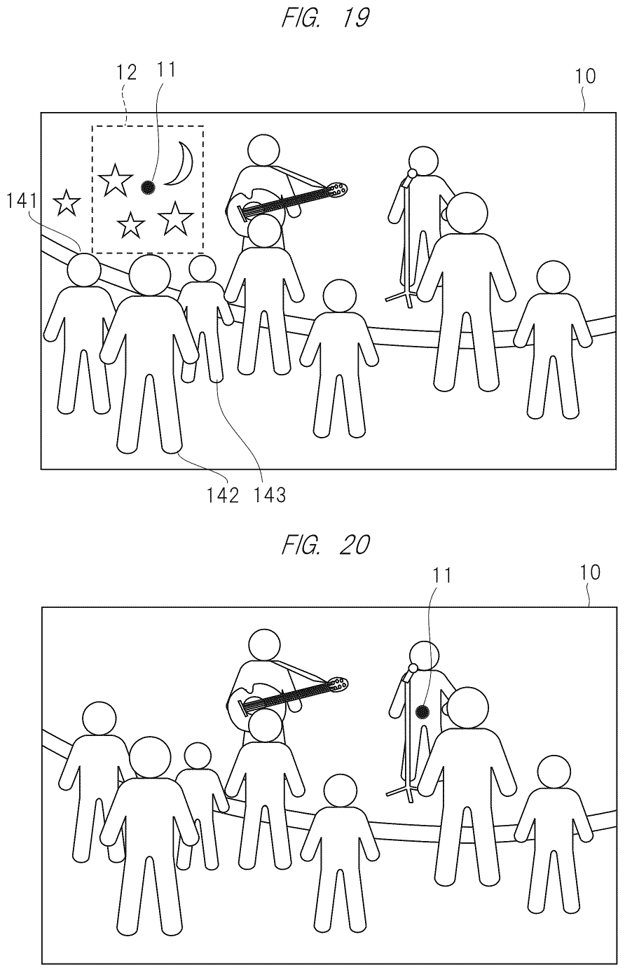

FIG. 20 illustrates a state in which the avatar existence space image 10 is expressed using the information processing apparatus 3. On the display screen of the display 311 of the information processing apparatus 3, the avatar existence space image 10 is displayed based on the information received from the server 1. In addition, the viewpoint 11 of the user 5 in the avatar existence space image 10 is detected based on the analysis result of the image including the eye of the user 5 captured by the front camera 303 of the information processing apparatus 3.

In a case where the movement amount of the viewpoint 11 of the user 5 is a predetermined amount or less for a predetermined time, a predetermined range including the viewpoint 11 of the user 5 is set as the region of interest 12 as illustrated in FIG. 21. In addition, when the region of interest 12 is set, in a case where the viewpoint of the user 5 is located on the image of a specific object, avatar, or real object, the specific image is set as the image of interest 13. In addition, a region including the entire image of interest 13 is set as the region of interest 12.

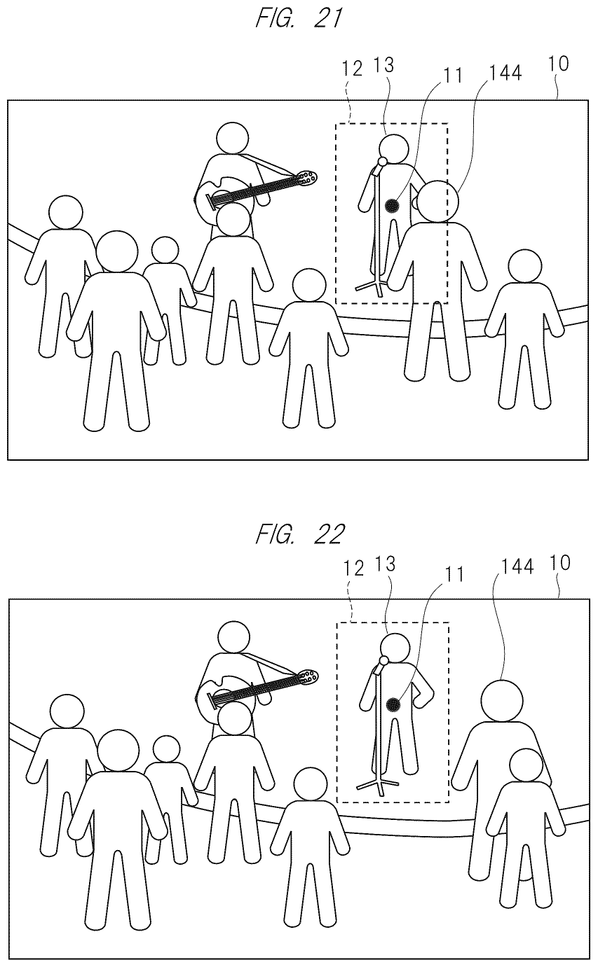

When the region of interest 12 is set, in the avatar existence space image 10 expressed through the display 311 of the information processing apparatus 3, in a case where at least a part of the avatar different from the image of interest 13 is located inside the region of interest 12, the avatar is specified as the display control target avatar 144. Then, as illustrated in FIG. 22, the display of the display control target avatar 144 is controlled such that the entire body of the display control target avatar 144 is located outside the region of interest 12.

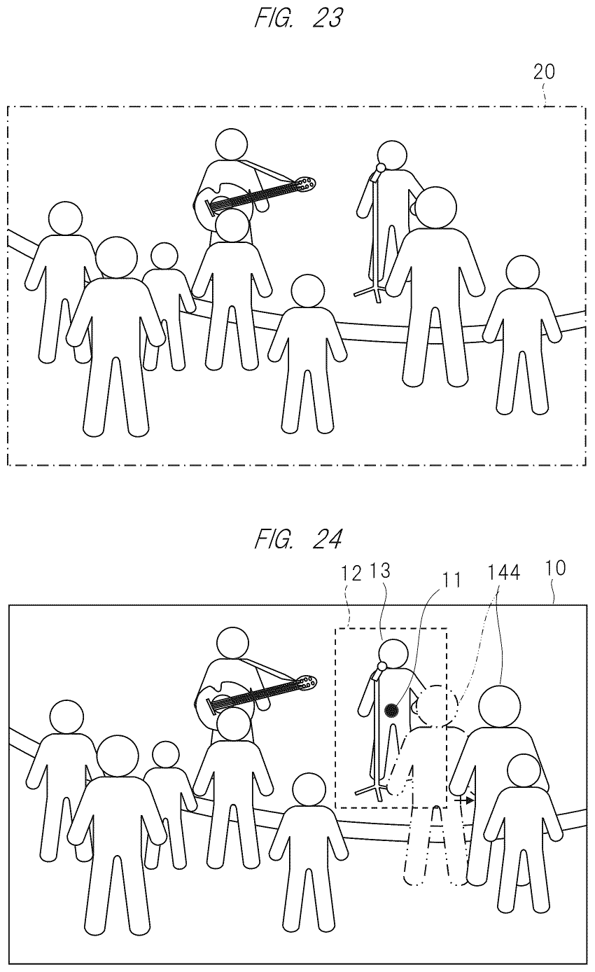

Note that, as illustrated in FIG. 23, an avatar existence space image 20 without display control, which is not subjected to the aforementioned avatar display control in the information processing apparatus 3 used by the user 5, is displayed on the screen of another information processing apparatus 4 used by another user 6 other than the user 5. Alternatively, although not illustrated, in a case where the another information processing apparatus 4 has at least the same configuration as the information processing apparatus 3 and the another information processing apparatus 4 executes the avatar display control, the another information processing apparatus 4 may perform display reflecting the avatar display control executed in the another information processing apparatus 4. The avatar display control performed by the information processing apparatus 3 may be considered to be an example of “first avatar display control” in the present invention, and the avatar display control performed by the another information processing apparatus 4 may be considered to be an example of “second avatar display control” in the present invention.

According to such avatar display control, by suppressing an alteration corresponding to the difference between the avatar existence space image 10 and the avatar existence space image 20 without display control to the necessary minimum, it is possible to ensure or maintain the visual recognition with respect to the region in which each user is considered to be interested together with the world view and the sense of presence of the avatar existence space while suppressing the difference in experience shared by each user to the necessary minimum.

### (Second Example)

A second example is an example of controlling the display of the avatar such that, among the avatars different from the image of interest 13, the avatar at least partially located inside the region of interest 12 gradually moves to the outside of the region of interest 12.

FIG. 24 is a diagram for describing the second example of the avatar display control. As illustrated in FIG. 24, it is assumed that the avatar existence space image 10 is displayed on the display screen of the display 311 of the information processing apparatus 3. In addition, it is assumed that the viewpoint of the user 5 is located on the image of a specific object, avatar, or real object. Further, it is assumed that the specific image is set as the image of interest 13, and a region including the entire image of interest 13 is set as the region of interest 12.

When the region of interest 12 is set, in the avatar existence space image expressed through the display 311 of the information processing apparatus 3, in a case where at least a part of the avatar different from the image of interest 13 is located inside the region of interest 12, the avatar is specified as the display control target avatar 144. Then, as illustrated in FIG. 24, the display of the display control target avatar 144 is controlled such that the entire body of the display control target avatar 144 moves gradually or stepwise so as to be located outside the region of interest 12. That is, the display of the display control target avatar 144 is controlled such that the display control target avatar 144 does not instantaneously move to another position suddenly. In addition, even when the avatar display control is released, the display control target avatar 144 may be subjected to the display control so as to move gradually or stepwise.

According to such avatar display control, it is possible to display the avatar so that the avatar moves slowly without instantaneously greatly changing the position of the avatar, and therefore, it is possible to make the movement of the avatar natural, and it is possible to suppress a decrease in the world view and the sense of presence of the avatar existence space.

### (Third Example)

A third example is an example of controlling the display of the avatar so that the avatar moving into the region of interest 12 does not enter the region of interest 12.

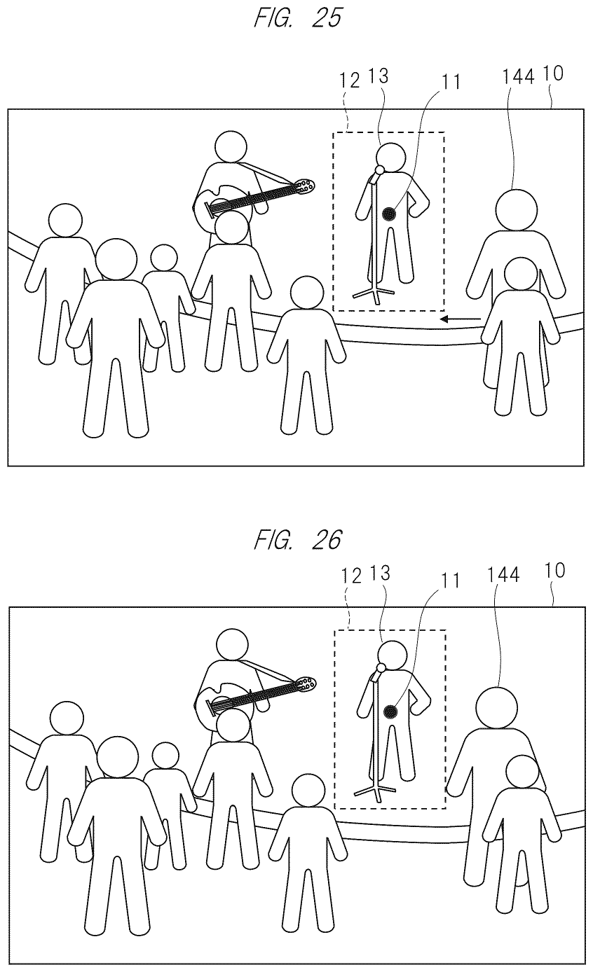

FIGS. 25 to 26 are diagrams for describing the third example of the avatar display control. As illustrated in FIG. 25, the avatar existence space image 10 is displayed on the display screen of the display 311 of the information processing apparatus 3. Here, as illustrated in FIG. 25, it is assumed that the viewpoint 11 of the user 5 is located on a specific avatar. The image of the specific avatar is set as the image of interest 13. In addition, a region including the entire image of interest 13 is set as the region of interest 12.

In the avatar existence space image 10, in a case where there is an avatar moving into the region of interest 12 among the avatars different from the image of interest 13, the avatar is specified as the display control target avatar 144. Then, as illustrated in FIG. 26, the display of the display control target avatar 144 is controlled such that the display control target avatar 144 does not enter the region of interest 12. For example, the display of the display control target avatar 144 is controlled such that the movement stops before the display control target avatar 144 enters the region of interest 12.

According to such avatar display control, the avatar different from the image of interest 13 does not move into the region of interest 12, and it is possible to maintain the visual recognition with respect to the region in which the user 5 is considered to be interested, together with the world view and the sense of presence of the avatar existence space.

### (Fourth Example)

A fourth example is an example in which, in a case where there is an avatar only partially located inside the region of interest 12 among the avatars different from the image of interest, only the display for the part is controlled.

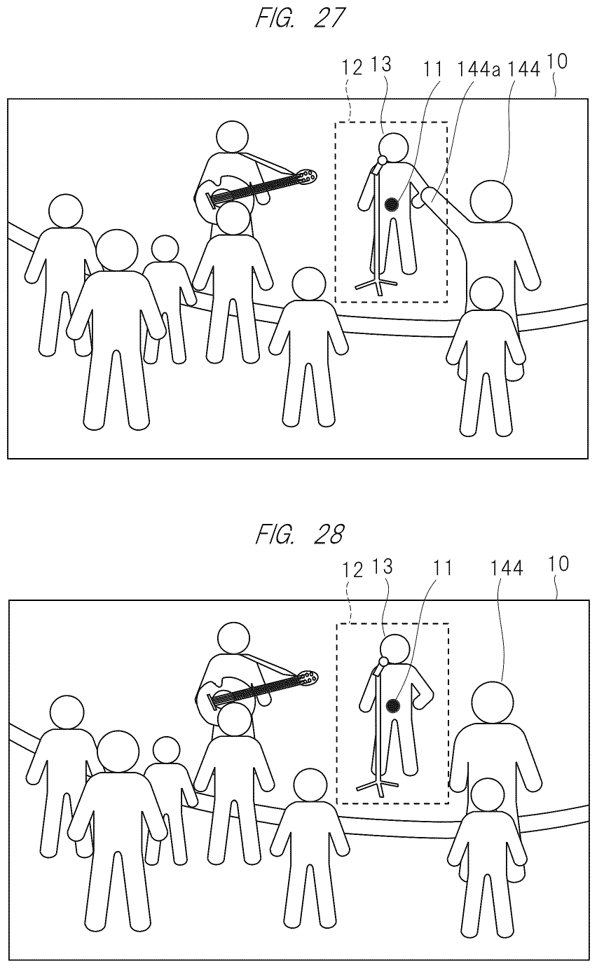

FIGS. 27 to 28 are diagrams for describing the fourth example of the avatar display control. In the example of FIG. 27, the avatar existence space image 10 is displayed on the display screen of the display 311 of the information processing apparatus 3. Here, as illustrated in FIG. 27, it is assumed that the viewpoint of the user 5 is located on a specific avatar. The image of the specific avatar is set as the image of interest 13. In addition, a region including the entire image of interest 13 is set as the region of interest 12.

In the avatar existence space image 10, there is an avatar partially included inside the region of interest 12 among the avatars different from the image of interest 13. The avatar is specified as the display control target avatar 144. Then, as illustrated in FIG. 28, the display of the display control target avatar 144 is controlled such that a part of the entire body of the display control target avatar 144 included inside the region of interest 12 is located outside the region of interest 12. For example, the display of a part 144a of the display control target avatar 144 is controlled such that the posture of the display control target avatar 144 is changed or only a part of the body is moved to be located outside the region of interest 12.

According to such avatar display control, it is possible to maintain the visual recognition of the user 5 with respect to the region of interest 12 or the image of interest 13 in the avatar existence space while maintaining the world view and the sense of presence of the avatar existence space by minimizing the avatar display control.

### (Fifth Example)

A fifth example is an example in which, in a case where there is an avatar at least partially located inside the region of interest 12 among avatars different from the image of interest 13, the display of the avatar is controlled such that the avatar is located outside the region of interest 12 and the distance between the avatars is equal to or more than a predetermined distance.

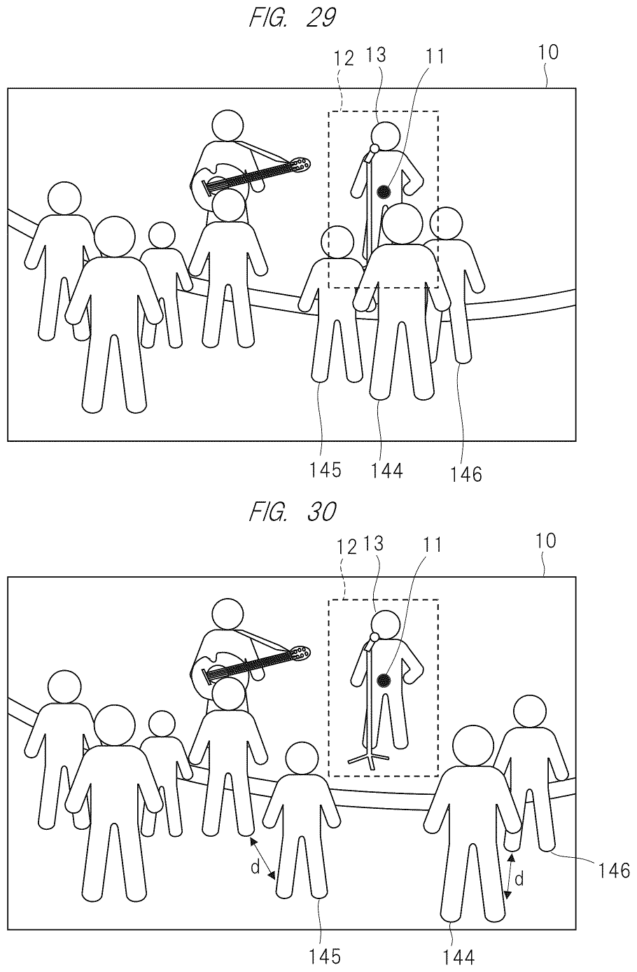

FIGS. 29 to 30 are diagrams for describing the fifth example of the avatar display control. In the example of FIG. 29, the avatar existence space image 10 is displayed on the display screen of the display 311 of the information processing apparatus 3. Here, as illustrated in FIG. 29, it is assumed that the viewpoint 11 of the user 5 is located on a specific avatar. The image of the specific avatar is set as the image of interest 13. In addition, a region including the entire image of interest 13 is set as the region of interest 12.

In the avatar existence space image 10, there is an avatar at least partially included inside the region of interest 12 among the avatars different from the image of interest 13. The avatar is specified as display control target avatars 144, 145, and 146. Then, as illustrated in FIG. 30, the display of the display control target avatars 144, 145, and 146 is controlled such that the display control target avatars 144, 145, and 146 are located outside the region of interest 12 and the distance d between the avatars is equal to or more than the predetermined distance d1. For example, the positions at which the display control target avatars 144, 145, and 146 are outside the region of interest 12 and the distance d to another avatar is equal to or more than the predetermined distance d1 are obtained, and the display of the display control target avatars 144, 145, and 146 is controlled such that the display control target avatars 144, 145, and 146 are displayed at the obtained positions. Note that, as illustrated in the examples of FIGS. 29 to 30, the display control target avatars 144, 145, and 146 are similarly controlled not only in the case of a plurality of avatars but also in the case of one avatar.

According to such avatar display control, it is possible to prevent the avatars from being unnaturally dense while performing the display control of the display control target avatar.

### (Sixth Example)

A sixth example is an example of controlling display of the avatar such that, when the avatar different from the image of interest crosses the region of interest 12, the avatar moves outside of the region of interest 12 to bypass the region of interest 12.

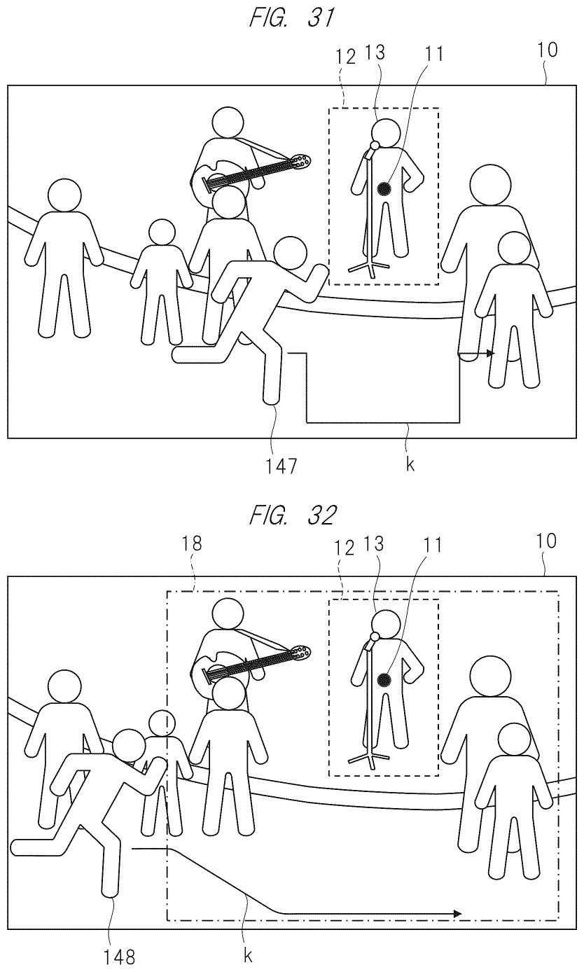

FIGS. 31 to 32 are diagrams for describing the sixth example of the avatar display control. In the example of FIG. 31, the avatar existence space image 10 is displayed on the display screen of the display 311 of the information processing apparatus 3. Here, as illustrated in FIG. 31, it is assumed that the viewpoint of the user 5 is located on a specific avatar. The image of the specific avatar is set as the image of interest 13. In addition, a region including the entire image of interest 13 is set as the region of interest 12.

In the avatar existence space image 10, there is an avatar crossing the region of interest 12 among the avatars different from the image of interest 13. The avatar is specified as a display control target avatar 147. Then, as indicated by an arrow k in FIG. 31, the display of the display control target avatar 147 is controlled such that the display control target avatar 147 moves to bypass or avoid the region of interest 12 outside the region of interest 12.

In the example of FIG. 32, the avatar existence space image 10 is displayed on the display screen of the display 311 of the information processing apparatus 3. Here, as illustrated in FIG. 32, it is assumed that the viewpoint 11 of the user 5 is located on a specific avatar. The image of the specific avatar is set as the image of interest 13. In addition, a region including the entire image of interest 13 is set as the region of interest 12. Further, a predetermined region that includes the entire region of interest 12 and is larger than the region of interest 12 is set as the enlarged region 18.

In the enlarged region 18 of the avatar existence space image 10, there is an avatar predicted to cross the region of interest 12 among the avatars different from the image of interest 13. The avatar is specified as a display control target avatar 148. Then, as indicated by an arrow k in FIG. 32, outside the region of interest 12, the display of the display control target avatar 148 is controlled such that the display control target avatar 148 moves, with an oblique movement, to bypass or avoid the region of interest 12.

Note that, in the sixth example, in a case where the display control target avatar moves to bypass or avoid the region of interest 12, the posture of the display control target avatar may be changed and displayed such that the orientation of the face, body, leg, or the like of the display control target avatar faces the advancing direction. In addition, the enlarged region 18 may be changed along with the change of the region of interest 12 so as to include at least the region of interest 12.

### (Seventh Example)

A seventh example is an example in which the specific image 16 representing a specific object, avatar, or real object selected by the user 5 is set as the image of interest 13, and a predetermined region including the image of interest 13 is set as the region of interest 12. The method of designation by the user 5 in this case may not be based on the position of the viewpoint 11 of the user 5, and may be, for example, a method of designation in which the user 5 performs an operation of touching the touch panel provided on the screen of the display 311 or an operation of displaying a pointer on the screen of the display 311 and performing selection by the user 5.

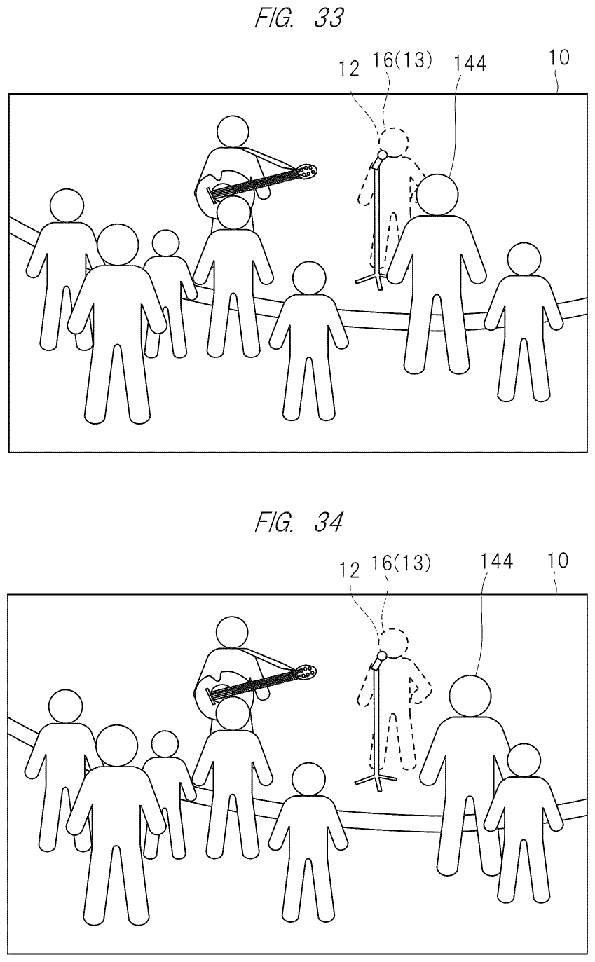

FIGS. 33 to 34 are diagrams for describing the seventh example of the avatar display control. In the example of FIG. 33, the avatar existence space image 10 is displayed on the display screen of the display 311 of the information processing apparatus 3. Here, as illustrated in FIG. 33, it is assumed that the specific image 16 of the specific avatar is selected by the user 5. The specific image 16 of the specific avatar is set as the image of interest 13. In addition, a region surrounded by the contour of the image of interest 13 is set as the region of interest 12.

In the avatar existence space image 10, there is an avatar at least partially included inside the region of interest 12 among the avatars different from the image of interest 13. The avatar is specified as the display control target avatar 144. Then, as illustrated in FIG. 34, the display of the display control target avatar 144 is controlled such that the entire display control target avatar 144 is located outside the region of interest 12.

According to such avatar display control, it is possible to ensure the visual recognition with respect to the image of interest 13 such as the avatar selected by the user 5 while maintaining the world view and the sense of presence of the avatar existence space.

### (Eighth Example)

An eighth example is an example in which, in a case where a part of the avatar representing the user 5 himself/herself or a part of the item carried by the avatar of the user 5 himself/herself is located inside the region of interest 12, the display of the avatar or the item is controlled such that the part is located outside the region of interest 12. Note that, as the setting as to whether or not to execute the avatar display control according to the relationship between the avatar different from the image of interest 13 and the user 5 or the avatar used by the user 5 illustrated in FIG. 12, it is assumed that the avatar display control is set to “execute” with respect to the avatar of the person himself/herself (the user himself/herself).

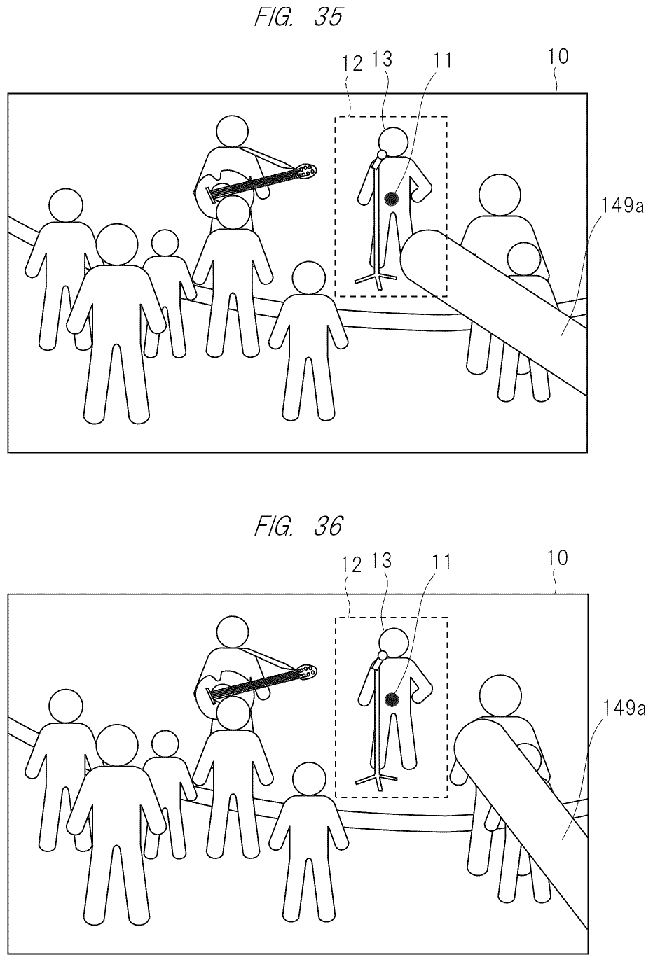

FIGS. 35 to 36 are diagrams for describing the eighth example of the avatar display control. In the example of FIG. 35, the avatar existence space image 10 is displayed on the display screen of the display 311 of the information processing apparatus 3. Here, as illustrated in FIG. 35, it is assumed that the viewpoint 11 of the user 5 is located on a specific avatar. The image of the specific avatar is set as the image of interest 13. In addition, a region including the entire image of interest 13 is set as the region of interest 12.

In the avatar existence space image 10, a part of the avatar of the user 5 himself/herself or at least a part of the item carried by the avatar of the user 5 himself/herself exists inside the region of interest 12. Here, a part of the item carried by the avatar of the user 5 himself/herself is specified as a part 149a of the display control target avatar. Then, as illustrated in FIG. 36, the display of the part 149a of the display control target avatar is controlled such that the part 149a of the display control target avatar is located outside the region of interest 12. Examples of the item include a penlight, a fan, and a plastic rod.

Note that the control of display may be performed on only a part of the avatar of the user 5 himself/herself or only a part of the item carried by the avatar of the user 5 himself/herself, or may be performed on the entire avatar of the user 5 himself/herself or the entire item carried by the avatar of the user 5 himself/herself.

According to such avatar display control, by performing the avatar display control in consideration of the movement of the avatar of the user 5 himself/herself and the movement of the item carried by the avatar, it is possible to ensure the visual recognition with respect to the specific visual field range in which the user 5 pays attention while maintaining the world view and the sense of presence of the avatar existence space.

### (Ninth Example)

A ninth example is an example in which a setting method, size, or shape of the region of interest 12 or the enlarged region 18 in the avatar existence space image 10 can be changed. Regarding the change of the setting regarding the region of interest 12 or the enlarged region 18, a billing system may be applied to the information processing system 1000, and the change may be made according to the completion of payment of the fee by the user 5 (release of restriction), or a range that can be changed according to the paid fee may be changed (switching of restriction).

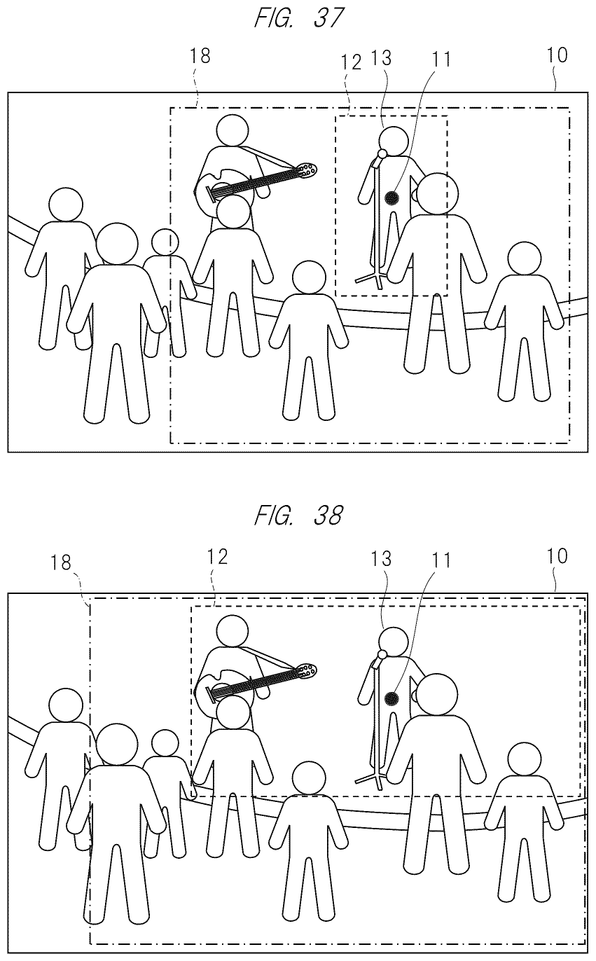

FIGS. 37 to 39 are diagrams for describing the ninth example of the avatar display control. The example of FIG. 37 illustrates a state in which the region of interest 12 and the enlarged region 18 are set based on the viewpoint 11 of the user 5 in the avatar existence space image 10. Here, regarding the setting method, shape, and size of the region of interest 12 and the enlarged region 18, specific settings are defined as initial settings. Then, when the user 5 pays a predetermined fee, the user 5 can change the setting method, shape, and size of the region of interest 12 and the enlarged region 18 to a desired setting method, shape, and size from among a plurality of options.

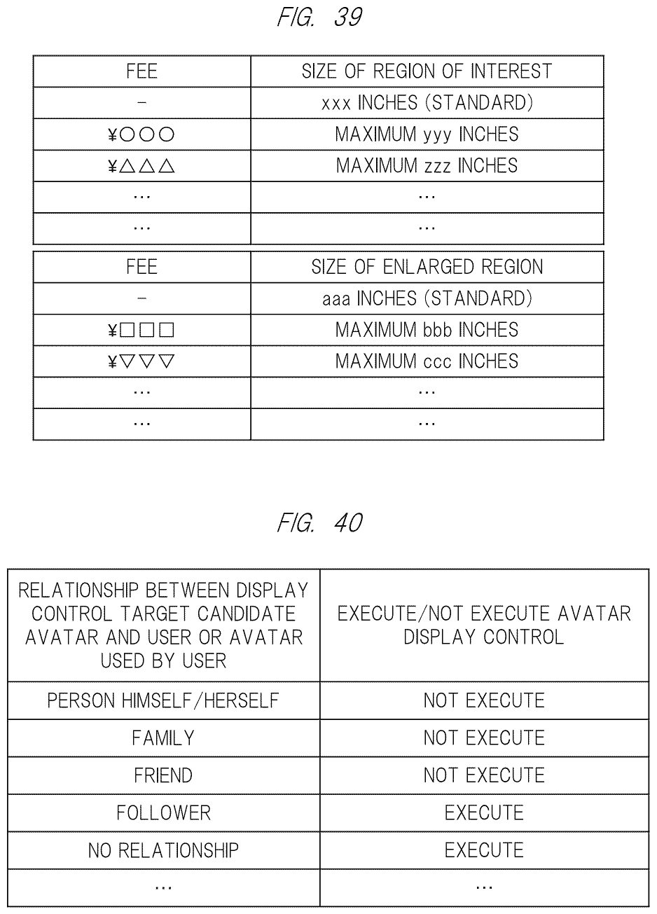

The example of FIG. 38 illustrates an example in which the shape and size of the region of interest 12 and the enlarged region 18 are changed to a desired shape and size by the user 5. In addition, as illustrated in FIG. 39, a plurality of fees to be paid may be set, and the degree of freedom in changing the region of interest 12 and the enlarged region 18, for example, the size (area) of the region of interest 12 and the enlarged region 18 may increase as the fees to be paid increase.

According to such a system in which the user 5 can change the setting of the region of interest 12 and the enlarged region 18, the region of interest 12 and the enlarged region 18 can be set in a form desired by the user 5, and the avatar display control suitable for the preference of the user 5 can be achieved. In other words, the user 5 can feel the avatar existence space in which discomfort and unnaturalness are further suppressed for the user 5. Further, when the billing system is introduced for change of the setting of the region of interest 12 or the enlarged region 18, it can be utilized as one of the business models.

### (Tenth Example)

A tenth example is an example in which whether or not to execute the display control of the avatar can be set according to the relationship between a display control target candidate avatar and the user 5 or the avatar used by the user 5. The display control target candidate avatar is an avatar that can be the display control target avatar, and is, for example, an avatar that is partially located inside the region of interest 12 or the enlarged region 18 and is different from the image of interest, an avatar that crosses or is predicted to cross the region of interest 12, or the like. Regarding the setting of the correspondence relationship between the relationship and the presence or absence of the avatar display control, a billing system may be applied to the information processing system 1000, and the setting change may be made according to the completion of payment of the fee by the user 5 (release of restriction), or a setting range that can be changed according to the paid fee may be changed (switching of restriction).

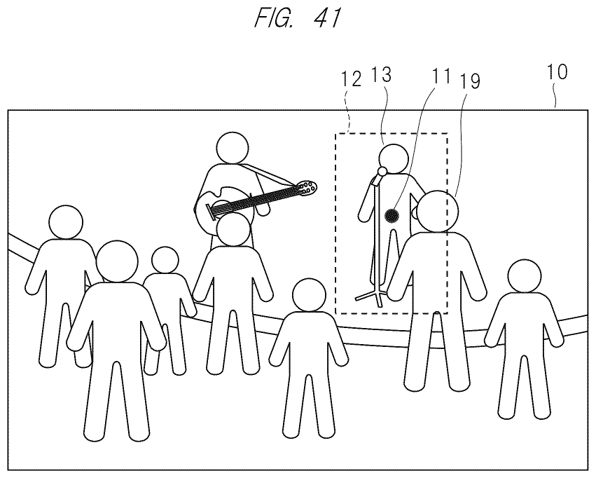

FIG. 40 is a table illustrating an example of the correspondence relationship between the relationship between the display control target candidate avatar and the user 5 or the avatar used by the user 5 and the setting as to whether or not to execute the avatar display control. In addition, FIG. 41 is a diagram illustrating an example of not executing the avatar display control based on the relationship between the display control target candidate avatar and the user 5 or the avatar used by the user 5.

In the example of FIG. 40, as examples of options of the relationship, the person himself/herself (the user 5 himself/herself), a family (families of the user 5), a friend (friends or acquaintances of the user 5), a follower (a person who is set as a person to follow the user 5 on social media), and no relationship are illustrated. In addition, in the example of FIG. 40, as an example of the setting as to whether or not to execute the avatar display control, the setting is illustrated in which the avatar display control is executed in a case where the relationship is either the follower or no relationship, and the avatar display control is not executed in a case where the relationship is any of the person himself/herself, the family, or the friend.

In the example of FIG. 41, the image of the avatar at a position overlapping the viewpoint 11 of the user 5 is set as the image of interest 13, and a region including the image of interest 13 is set as the region of interest 12. In addition, it is assumed that the avatar partially located inside the region of interest 12, that is, an image 19 of the display control target candidate avatar is the avatar of the user 5 registered as a friend of the user 5. The image 19 of the display control target candidate avatar is originally subjected to the display control so as to be located outside the region of interest 12 under the display control. However, in the present example, the display control is set not to be executed for the avatar of another user 5 having a friend relationship with the user 5 himself/herself. Accordingly, the image 19 of the display control target candidate avatar is not subjected to the display control, and the display is maintained while overlapping the region of interest 12.

For a certain user 5, an avatar whose relationship is a family or a friend is in a close relationship with the user 5, and there may be a case where the user 5 does not feel that the avatar is an obstacle when visually recognizing the image of interest, but rather feels natural. In addition, for a certain user 5, in the avatar existence space, it is conceivable that the user 5 wishes the avatar of a certain person having a relationship with which the user 5 wishes to have communication to be at a natural position or a position close to the user 5 regardless of the positional relationship with the image of interest. In a case where an avatar of a person whom the user wishes to communicate is not present nearby under the display control of the avatar, a difference in recognition of mutual positions occurs, which is a factor that hinders communication. On the other hand, regardless of the relationship, a certain user 5 may feel that any avatar different from the image of interest becomes an obstacle when visually recognizing the image of interest.

As described above, it is expected that the way of feeling and the significance of existence with respect to the avatar different from the image of interest are different depending on the personality, the way of thinking, the sensitivity, the social position, and the like of the user 5. In consideration of such circumstances, when it is possible to arbitrarily set whether or not to execute the display control of the avatar according to the relationship between the display control target candidate avatar and the user 5 or the avatar used by the user 5, it is possible to achieve the avatar display control in which the position of the avatar is optimized for each user 5. Further, when the billing system is introduced for change of the setting of the correspondence relationship between the relationship and the presence or absence of the avatar display control, it can be utilized as one of the business models.

As described above, the above-described embodiment, modification, and examples have been described in detail in order to describe the present invention in an easy-to-understand manner, and are not necessarily limited to those having all the described configurations. In addition, a part of the configuration of a certain example can be replaced with the configuration of another example, and the configuration of another example can be added to the configuration of a certain example. In addition, it is possible to add, delete, and replace other configurations for a part of the configuration of each example.

For example, in each of the above-described examples, the enlarged region 18 including the region of interest 12 may be set in the avatar existence space image 10, and the avatar at least partially included inside the region of interest 12 may be set as a candidate for the display control target avatar. In addition, for example, in each of the above-described examples, the avatar existence space image 10 is expressed from the first-person perspective of the user 5 (the avatar of the user 5 does not appear in the avatar existence space image 10), but it is not limited thereto, and may be expressed from the third-person perspective (the avatar of the user 5 appears in the avatar existence space image 10). In addition, for example, in each of the above-described examples, the avatar existence space image 10 may be an image representing augmented reality in which an image of a real object (for example, two persons on a stage) and a virtual object (for example, including an avatar of another user 5) are mixed, or may be an image representing virtual reality in which everything is drawn with an image representing a virtual object. In addition, for example, the server 1 may include at least a processor, a memory, and a configuration similar to the functional block configuration illustrated in FIG. 4, and the server 1 may perform each processing illustrated in FIG. 15 in cooperation with the information processing apparatus 3 connected via the network 2, and the information processing apparatus 3 may be configured to receive each processing content in the server 1 from the server 1. As a result, the processing amount, that is, the load of the information processing apparatus 3 can be greatly reduced.

In addition, the configurations of the above-described embodiment, modification, and examples may be configured by hardware by designing some or all of them with, for example, an integrated circuit, a general-purpose processor, or a specific purpose processor. The processor includes a transistor and other circuits, and may be regarded as circuitry or processing circuitry. In addition, each of the above configurations may be configured to be achieved by executing a program by the processor. In addition, control lines and information lines indicate what is considered to be necessary for the description, and do not necessarily indicate all the control lines and the information lines of a product. In practice, it may be considered that almost all the configurations are connected to each other.

### <Appendix>

### [Appendix 1]

An information processing apparatus configured to cause a user to feel a space where an avatar exists, the information processing apparatus including:
a display connected to a server configured to provide at least a part of the space via a network and configured to display an image for expressing the space based on information received from the server,
wherein the information processing apparatus is configured to execute, in cooperation with the server,
region setting processing of setting a first region in which a first user who uses the information processing apparatus is considered to be interested in the image displayed on the display;
avatar specifying processing of specifying, in the image displayed on the display, a first avatar different from an image of interest that is an image in which the first user is considered to be interested, based on a positional relationship with the first region; and
avatar display control processing of controlling display of the first avatar such that the first avatar is entirely displayed outside the first region.

### [Appendix 2]

The information processing apparatus according to appendix 1,
wherein the avatar specifying processing includes processing of specifying, as the first avatar, an avatar that is a moving avatar and that is expected to at least partially enter the first region.

### [Appendix 3]

The information processing apparatus according to appendix 2,
wherein the avatar display control processing includes processing of controlling the display of the first avatar such that the first avatar moves to avoid or bypass the first region.

### [Appendix 4]

The information processing apparatus according to appendix 3,
wherein the avatar display control processing includes processing of controlling the display of the first avatar so as to change an orientation to a direction in which the first avatar moves.

### [Appendix 5]

The information processing apparatus according to appendix 1,
wherein the avatar display control processing includes processing of controlling display of at least a part of an avatar corresponding to the first user or an item carried by the avatar such that the at least a part of the avatar or the item carried by the avatar is displayed outside the first region in a case where the at least a part of the avatar or the item carried by the avatar is included or predicted to be included in the first region.

### [Appendix 6]

The information processing apparatus according to appendix 1,
wherein the region setting processing includes processing of permitting a change in condition for setting the first region by billing.

### [Appendix 7]

The information processing apparatus according to appendix 1,
wherein the avatar display control processing includes processing of permitting a change in condition for controlling the display of the first avatar by billing.

### [Appendix 8]

The information processing apparatus according to appendix 1,
wherein the region setting processing includes processing of setting, as the first region, a region having a polygonal shape, a rectangular shape, an elliptical shape, a perfect circular shape, or a shape of a contour of the first avatar or a shape obtained by enlarging the contour.

### [Appendix 9]

The information processing apparatus according to appendix 3,
wherein the region setting processing includes processing of setting a second region that includes the first region and is larger than the first region, and
wherein the avatar display control processing includes processing of setting an avatar at least partially included in the second region as a specific target of the first avatar.

### [Appendix 10]

The information processing apparatus according to appendix 1,
wherein the display includes a first display configured to display a first image that can be visually recognized only by the first user and a second display configured to display a second image that can be visually recognized by a person different from the first user, and
wherein the avatar display control processing includes processing of controlling display of the first avatar only in the first image out of the first image and the second image.

### [Appendix 11]

The information processing apparatus according to appendix 1,
wherein the first information processing apparatus includes a head-mounted display or a portable information terminal.

### [Appendix 12]

The information processing apparatus according to appendix 1,
wherein the avatar specifying processing includes processing of including an avatar corresponding to the first user in a specific target and specifying the first avatar.

### [Appendix 13]

The information processing apparatus according to appendix 1,
wherein the space represents virtual reality, augmented reality, or mixed reality.

### [Appendix 14]

A program for causing a user to feel a space where an avatar exists,
wherein the program is configured to cause a computer constituting an information processing apparatus including a display connected to a server configured to provide at least a part of the space via a network to execute,
in cooperation with the server,
processing of executing processing of causing the display to display an image for expressing the space based on information received from the server,
processing of setting a first region in which a first user who uses the information processing apparatus is considered to be interested in the image displayed on the display,
processing of specifying, in the image displayed on the display, a first avatar different from an image of interest that is an image in which the first user is considered to be interested, based on a positional relationship with the first region, and
processing of controlling display of the first avatar such that the first avatar is entirely displayed outside the first region.

### [Appendix 15]

A non-transitory tangible computer-readable storage medium storing the program according to appendix 14.

### REFERENCE SIGNS LIST

1 Server
2 Network
3 Information processing apparatus
4 Another information processing apparatus
3a Video see-through type head-mounted display (HMD)
3b Optical see-through type head-mounted display
3c Information portable terminal
5 User
6 Another user
10 Avatar existence space image
11 Viewpoint
12 Region of interest
13 Image of interest
141 to 148 Display control target avatar
144a, 149a Part of display control target avatar
15 Designated position
16 Specific image
18 Enlarged region
19 Image of display control target candidate avatar
20 Avatar existence space image without display control
301 Communication bus
302 Rear camera
303 Front camera
304 Ranging sensor
305 Acceleration sensor
306 Gyro sensor
307 Geomagnetic sensor
308 Positioning sensor
309 Network transceiver
311 Display
312 Microphone
313 Loud speaker
314 Timer
315 Processor
316 Operation unit
317 Memory
321 Main controller
322 Region-of-interest setting method setting unit
323 Image-of-interest specifying method setting unit
324 Region-of-interest setting start condition setting unit
325 Avatar display control start condition setting unit
326 Avatar display control release condition setting unit
327 Region-of-interest setting unit
328 Avatar display controller
330 Region-of-interest setting method storage
331 Image-of-interest specifying method storage
332 Region-of-interest setting start condition storage
333 Avatar display control start condition storage
334 Avatar display control release condition storage
1000 Information processing system

1. An information processing apparatus configured to cause a user to feel a space where an avatar exists, the information processing apparatus comprising:
a transceiver;
a display connected to a server configured to provide at least a part of the space via a network and configured to display an image for expressing the space based on information received from the server; and
a processor,
wherein the information processing apparatus is configured to execute, in cooperation with the server,
region setting processing of setting a first region in which a first user who uses the information processing apparatus is considered to be interested in the image displayed on the display;
avatar specifying processing of specifying, in the image displayed on the display, a first avatar different from an image of interest that is an image in which the first user is considered to be interested, based on a positional relationship with the first region; and
avatar display control processing of controlling display of the first avatar such that the first avatar is entirely displayed outside the first region in the image displayed on the display.

2. The information processing apparatus according to claim 1,
wherein the avatar specifying processing includes processing of specifying an avatar that is only partially included inside the first region as the first avatar.

3. The information processing apparatus according to claim 1,
wherein the information processing apparatus is configured to execute processing of detecting a viewpoint of the first user in the image displayed on the display, and
wherein the region setting processing includes processing of setting a region including a position of the detected viewpoint as the first region.

4. The information processing apparatus according to claim 3,
wherein the region setting processing includes processing of setting a region including the position of the viewpoint of the first user as the first region in a case where a movement amount of the viewpoint of the first user during a first duration is equal to or less than a first amount.

5. The information processing apparatus according to claim 3,
wherein the region setting processing includes processing of setting a region including an entire image representing an object, avatar, or real object overlapping the viewpoint as the first region.

6. The information processing apparatus according to claim 2,
wherein the avatar display control processing includes processing of controlling the display of the first avatar such that the first avatar moves to the outside of the first region stepwise.

7. The information processing apparatus according to claim 1,
wherein the avatar specifying processing includes processing of specifying, as the first avatar, an avatar that is a moving avatar and that at least partially enters inside of the first region or is expected to enter the inside of the first region.

8. The information processing apparatus according to claim 7,
wherein the avatar display control processing includes processing of controlling the display of the first avatar such that the first avatar moves to avoid or bypass the first region.

9. The information processing apparatus according to claim 1,
wherein the region setting processing includes processing of setting a region including a position designated by the first user in the image displayed on the display as the first region.

10. The information processing apparatus according to claim 1,
wherein the avatar display control processing includes processing of controlling only display of a part of the first avatar

11. The information processing apparatus according to claim 1,
wherein the avatar display control processing includes processing of controlling the display of the first avatar such that the first avatar is separated from another avatar different from the first avatar by a first distance or more in the space.

12. The information processing apparatus according to claim 1,
wherein the region setting processing includes processing of setting a region including an image representing an object, avatar, or real object selected by the first user as the first region in the image displayed on the display.

13. The information processing apparatus according to claim 1,
wherein the avatar display control processing includes processing of determining whether or not to control the display of the first avatar in accordance with a relationship between the first user or an avatar used by the first user and the first avatar.

14. An information processing system configured to cause a user to feel a space where an avatar exists, the information processing system comprising:
a server configured to provide at least a part of the space;
a first information processing apparatus connected to the server via a network; and
a second information processing apparatus connected to the server via a network,
wherein the first information processing apparatus includes
a first transceiver,
a first display configured to display an image for expressing the space based on information received from the server, and
a first processor,
wherein the first information processing apparatus is configured to
execute, in cooperation with the server,
region setting processing of setting a first region in which a first user who uses the first information processing apparatus is considered to be interested in the image displayed on the first display,
avatar specifying processing of specifying, in the image displayed on the first display, a first avatar different from an image of interest that is an image in which the first user is considered to be interested, based on a positional relationship with the first region, and
avatar display control processing of controlling display of the first avatar such that the first avatar is entirely displayed outside the first region in the image displayed on the first display,
wherein the second information processing system includes
a second transceiver,
a second display configured to display an image for expressing the space based on information received from the server, and
a second processor, and
wherein the second information processing system is configured not to perform display reflecting the avatar display control processing.

15. An information processing method of causing a user to feel a space where an avatar exists,
wherein an information processing apparatus, including a display connected to a server configured to provide at least a part of the space via a network and configured to display an image for expressing the space based on information received from the server, is configured to,
in cooperation with the server,
set a first region in which a first user who uses the information processing apparatus is considered to be interested in the image displayed on the display,
specify, in the image displayed on the display, a first avatar different from an image of interest that is an image in which the first user is considered to be interested, based on a positional relationship with the first region, and
control display of the first avatar such that the first avatar is entirely displayed outside the first region in the image displayed on the display.
